(19) United States
(12) Patent Application Publication
(10) Pub. No.: US 2017/0270445 A1
(43) Pub. Date: Sep. 21, 2017

(54) SYSTEM, APPARATUS AND METHOD FOR GENERATING A PROPOSED STATE BASED ON A CONTRACT

(71) Applicant: Kenji HAGIWARA, Edgewater, NJ (US)

(72) Inventor: Kenji HAGIWARA, Edgewater, NJ (US)

(73) Assignee: RICOH COMPANY, LTD., Tokyo (JP)

(21) Appl. No.: 15/071,089

(22) Filed: Mar. 15, 2016

(51) Int. Cl. G06Q 10/06; G06Q 50/18

(52) U.S. Cl. CPC G06Q 10/06313; G06Q 50/18

(57) ABSTRACT

Systems, apparatuses, application software and methodologies are configured for generating automatically a proposed state (e.g., a proposed fleet of devices), for an enterprise or another organization, based on device models specified in a contract or proposed contract. Thus, obtaining a proposed state analysis can become a manageable task.

### TECHNICAL FIELD

This disclosure relates to systems, apparatuses, methodologies, application software and other tools for generating a proposed state, and more specifically, such tools including provisions to generate a proposed state based on device models specified in a contract or proposed contract.

### BACKGROUND

In the current information age, information technology (IT) tools are extensively used in enterprises and other organizations in order to facilitate communication and processing of information, documents, data, etc. Indeed, it is now rare to find a workflow in an enterprise that does not employ IT tools. The number of IT assets [such as software, computers, printers, scanners, multi-function devices (MFDs), other network-connected or standalone devices] is generally increasing and, as a result, managing IT assets to meet enterprise needs is becoming a daunting task.

One approach for a vendor to make an educated and intriguing sales pitch to a customer or prospective customer is to present a proposal along with an analysis of the current IT expenditures of the customer or prospective customer. For example, a customer may wish to know, and a current state analysis may be prepared to show, total cost of ownership, or expected expenditures (such as for consumables) for devices [e.g., printers, scanners, facsimile devices, multi-function peripherals (MFP), etc.] for each period of one or more months, a year, 3 years, etc., output volumes, etc. Accordingly, the vendor typically attempts to determine the current IT assets of the customer or prospective customer and then collate information such as, but not limited to, acquisition type (i.e. lease/purchase), acquisition cost, depreciation of product, service cost, and in the case of printing products/services, consumables (e.g., paper, ink, toner, etc.) usage or cost, output, etc. Further, the vendor may analyze the needs of the customer or prospective customer in order to be able to offer a package of products and/or services that is attractive to the customer or prospective customer.

However, there exists a need for an improved approach for generating a proposed fleet of devices for consideration.

### SUMMARY

Various tools (e.g., systems, apparatuses, methodologies, application software, computer program products, etc.) can be configured to include any combination of various aspects and features described herein, to facilitate generation of a proposed state (e.g., a proposed fleet of output devices) for an enterprise (or another organization) or an enterprise site. Such tools can be employed by sales or marketing personnel, as well as by a customer, in a case of new sale, as well as in the instance of contract renewal, to obtain a proposed state analysis of a proposed fleet for the customer. Such tool can be configured to generate automatically a proposed state based on device models specified in a contract or proposed contract.

While the proposed state generation is automated as much as possible, it is generally desirable for the tool (e.g., a device and service management application) to provide the user with an application user interface to permit the user to modify and edit the proposed state. Such application user interface may also permit a user to specify (i) a site or customer for which a proposed state analysis is to be prepared and (ii) a contract name or code applying to the specified site or customer, and request the proposed state analysis to be prepared in view of the existing contract and current state. For example, the application may include a proposed state creation module to retrieve contract data including device models indicated in a contract corresponding to the specified contract name or code, and the current state (e.g., a current fleet of image forming devices of the specified customer or customer site) is employed as a starting point for the proposed state. More specifically, the devices may be considered in turn to determine whether the device is a replacement target and if the device is a replacement target, find a best-fit replacement device for the replacement target. The application user interface permits the user to replace the replacement device proposed by the application with a user specified device or to request another proposal for replacing the target. The user interface may also permit the select a device in the current state that the application has not determined to be a replacement target and request a replacement proposal or specify a replacement device for the selected device.

The tool may be configured to determine, for a customer under contract and when the current state of a customer includes devices (and/or device models) under contract, a replacement device for each replacement target (e.g., device under contract). Such replacement device may be a device of a best-fit device model amongst plural device models registered in a device database. Such best-fit replacement device may be the same device type as the replacement target, may have the same mono-color capability as that of the replacement target, and may have a similar recommended output volume as that of the replacement target. Other device parameters, features and functionalities may be considered for determining whether a replacement device or model is a best-fit. For example, a device may be considered to be an unacceptable replacement device if a release date of the device model of such device is not more recent than a user-specified old device date or is not more recent than that of the replacement target.

In another aspect, replacement targets may be determined in any of various ways. For example, if a device in the current state is any of the device models specified by the contract, the device is a replacement target, and/or each device under contract may be considered separately as replacement target, and/or each device model specified in the contract may be a replacement target to be replaced by a replacement model. Further, additional qualifications may be added, such as whether a release date of such device is not more recent than a user-specified old device date (and thus must be replaced) or is more recent than a user-specified new device date (and thus need not be replaced).

In addition, the application user interface can alternatively or additionally be configured to display a list of the plural device models registered in the device database and permit the user to select a replacement model from the list for a specified device model amongst the device models specified by the contract. In such instance, for each replacement target corresponding to the specified device model, the proposed state creation module replaces the replacement target with a replacement device of the corresponding user-selected replacement model.

In another aspect of this disclosure, when a new contract has been executed or proposed and a proposed state is to be formulated, based on the new contract, to replace the current state, the proposed state creation module retrieves data including device models indicated in the new contract, and the current state again is employed as a starting point for the proposed state. Each device copied initially into the proposed state can be considered in turn to determine whether the device is a replacement target and if the device is a replacement target, find a best-fit replacement device from amongst the device models specified in the new contract. The application may be configured to replace any current device that is not one of the device models specified in the new contract, or is not a device of a relatively new vintage (e.g., release date). In the case that an existing is being replaced by a new contract, the application may be configured to determine whether the replacement target is one of the device models specified by the current contract, and if it is such a device model, replace the target with a replacement device of a best-fit new device model, determined based on a comparison of the replacement target with the new device models specified by the new contract.

The application user interface permits the user to replace the replacement device proposed by the application with a user specified device or to request another proposal for replacing the target. The user interface may also permit the user to select a device in the current state that the application has not determined to be a replacement target (e.g., when such device is not a device model specified in the existing contract) and request a replacement proposal or specify a replacement device for the selected device.

### BRIEF DESCRIPTION OF THE DRAWINGS

The aforementioned and other aspects, features and advantages can be more readily understood from the following detailed description with reference to the accompanying drawings wherein:

FIG. 1A shows a block diagram of a system within which a device and service management application can operate to generate a proposed state (e.g., proposed fleet of devices) and/or proposed state analysis for a customer or customer site, according to an exemplary embodiment;

FIG. 1B shows a block diagram of a system within which a device and service management application can operate to generate a proposed state and/or proposed state analysis, according to another exemplary embodiment;

FIG. 2 shows a block diagram of an exemplary configuration of a computing device that can be configured by software to operate as an application server, web server, or another server;

FIG. 3 shows a block diagram of an exemplary configuration of a terminal or a terminal apparatus from which a user can access a device and service management application;

FIG. 4 shows a block diagram of an exemplary configuration of a multi-function device as an example of an output device or image forming device;

FIG. 5A shows a contract table as an example of contract data in a contracts database;

FIG. 5B shows a contract model table as an example of contract data in a contracts database;

FIG. 5C shows an analysis table as an example of data in a contracts database or in a state analysis database;

FIG. 6 shows a flow chart of a method, according to an exemplary embodiment, which can be performed in any of the systems shown in FIGS. 1A and 1B;

FIGS. 7A-7H show respective examples of user interface screens provided by a device and service management application, according to an exemplary embodiment;

FIG. 8 shows a flow chart of a method, according to an exemplary embodiment, which can be performed in any of the systems shown in FIGS. 1A and 1B;

FIGS. 9A-9F show respective examples of user interface screens provided by a device and service management application, according to an exemplary embodiment;

FIG. 10 shows a flow chart of a method, according to an exemplary embodiment, which can be performed in any of the systems shown in FIGS. 1A and 1B;

FIGS. 11A-11E show respective examples of user interface screens provided by a device and service management application, according to an exemplary embodiment; and

FIG. 12 shows a flow chart of a method, according to an exemplary embodiment, which can be performed in any of the systems shown in FIGS. 1A and 1B.

### DETAILED DESCRIPTION

In describing exemplary embodiments illustrated in the drawings, specific terminology is employed herein for the sake of clarity. However, this disclosure is not intended to be limited to the specific terminology so selected and it is to be understood that each specific element includes all technical equivalents that operate in a similar manner. In addition, a detailed description of known functions and configurations is omitted from this specification when it may obscure the inventive aspects described herein.

Various aspects of proposed state generation are discussed herein, with reference to a device and service management application. It should be appreciated by those skilled in the art that any one or more of such aspects or features may be embedded in another application and/or in any of various other ways, and thus while various examples are discussed herein, the inventive aspects of this disclosure are not limited to such examples described herein.

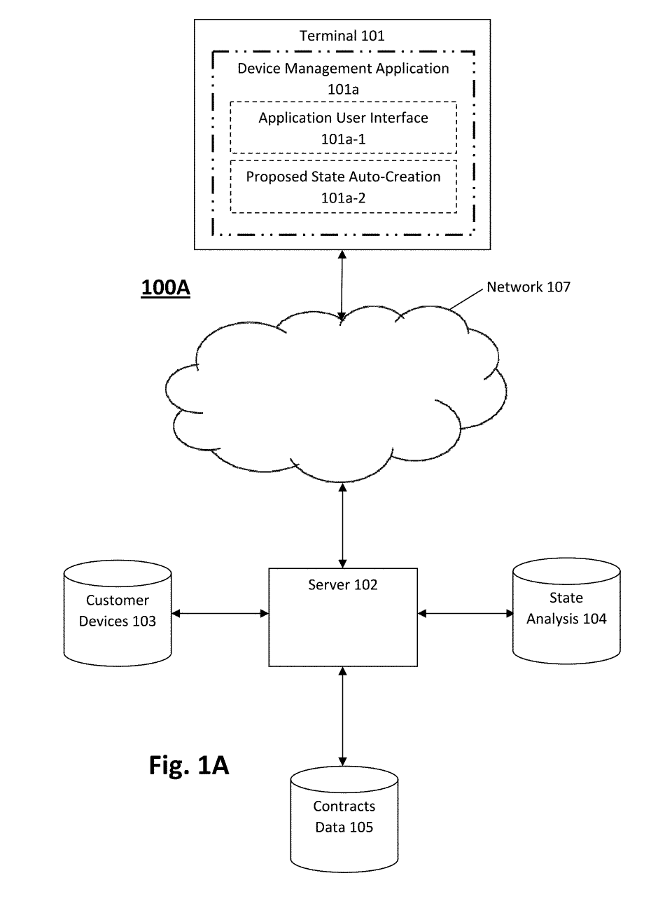

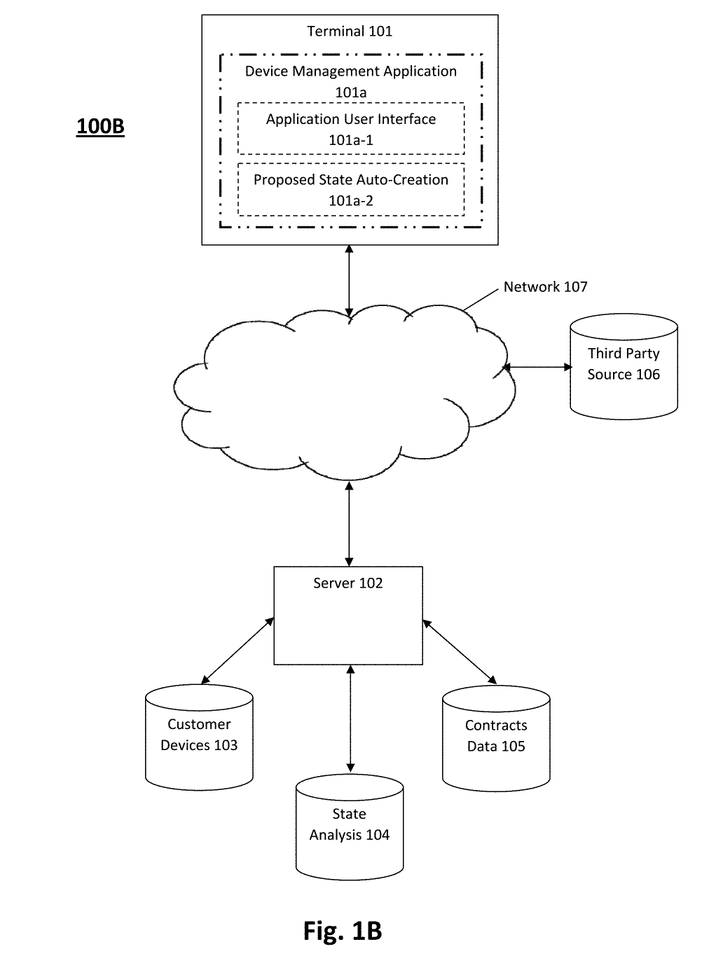

FIG. 1A shows schematically a system 100A that includes a terminal 101 and a server 102, which are interconnected by network 107. Although only one terminal is shown in FIG. 1A, it should be understood that a plurality of terminal devices (which can have similar or different configurations) can be provided in the system.

The terminal 101 can be any computing device, including but not limited to a personal, notebook, tablet or workstation computer, a mobile phone or handset, another information terminal, etc., that can communicate with other devices through the network 107. The terminal 101 is further described infra with reference to FIG. 3.

In the system shown in FIG. 1A, a device and service management application 101a is provided on or to a terminal 101, and includes an application user interface 101a-1 and proposed state creation module 101a-2.

The terminal 101 can be any computing device, including but not limited to a personal, notebook or workstation computer, a kiosk, a PDA (personal digital assistant), a mobile phone or handset, another information terminal, etc., that can communicate with other devices through the network 107. The terminal 101 is further described infra with reference to FIG. 3.

The device and service management application 101a may be provided on or to the terminal 101 to display a user interface through which a user can request an analysis of a fleet of devices. Such application may be a native program installed on the terminal 101, or may be provided from an external source as an application and/or as part of a platform or service (e.g., software as a service, i.e. SaaS), or may be provided as a web page.

Further, the device and service management application 101a is configured to perform analysis and calculations with regards to a set (or fleet) of one or more specified devices. Such analysis may be performed on an existing set of devices (e.g., a fleet of devices employed by a particular organization) or a proposed set of devices (e.g., a list of devices recommended to a particular organization for purchase, lease, etc.). Such analysis may be performed for the purpose of determining a set of devices that can meet the needs of a customer, in an optimal manner preferably.

When, for example, a new customer seeks a proposal for updating its fleet of output devices, a vendor would typically like to know what devices are currently employed by the customer in the customer's fleet. Such information may be sent to the vendor in various forms. For example, the customer may send a list of the devices constituting the current fleet to the vendor in an electronic format (e.g., spreadsheet, e-mail, etc.) or by paper (e.g., handwriting, typed, etc.). In another example, the customer may simply tell the vendor (e.g., meetings, telephone conference, etc.) what devices the specific customer currently possesses. After receiving information regarding the current devices from the specific customer, the vendor can utilize (that is, as a user of) the device and service management application 101a to create a current state analysis which includes the list of devices currently possessed by the customer. It should be noted that the analysis may be performed for each device individually and/or the entirety of the devices at a site.

The application user interface (UI) 101a-1 permits the user of the terminal 101 to request a proposed state analysis. When the user makes such a request, a copy of the current state analysis data can be employed as an initial starting point for a proposed state. For example, such a copy includes all of the devices that were in the selected current state analysis. Further, the application user interface 101a-1 also receives a contract identifier (e.g., name, ID, code) that corresponds to a contract made with a specific customer. In one exemplary embodiment, the contract identifier may correspond to an existing contract with a specific customer. In another exemplary embodiment, the contract identifier may correspond to a new contract (or new proposed contract) for a specific customer. Such new contract may have already been executed, but not yet implemented since the date of implementation that was decided by the two parties has not yet occurred.

The proposed state creation module 101a-2 retrieves contract data associated with the contract identifier received by the application user interface 101a-1. In one exemplary embodiment, after retrieving the current contract data, the proposed state creation module 101a-2 searches for devices in the proposed state and determines if there are any devices in the proposed state that matches a device model in the contract data. In the case that there is, the proposed state creation module 101a-2 performs a search for replacement devices that have similar properties (e.g., same mono-color capability, similar recommended output, same device type) as the matched device. If a replacement device is found that (i) has similar properties and (ii) a more recent release date, the proposed state creation module 101a-2 replaces that matched device with the replacement device.

In another exemplary embodiment, after retrieving the current contract data and the new contract data, the proposed state creation module 101a-2 searches for devices in the proposed state and determines if there are any devices in the proposed state that matches a device model in the contract data. In the case that there is, the proposed state creation module 101a-2 automatically replaces each of the matched devices with the device model found in the new contract data.

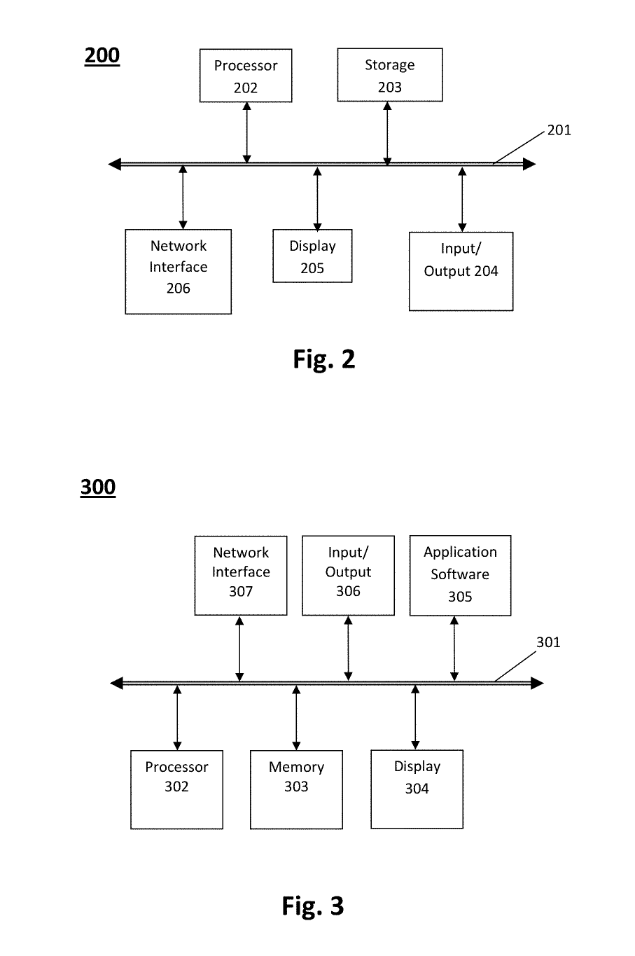

The server 102 may be used to access information regarding customer device models, state analyses and contracts data which are stored in the customer devices database 103, state analyses database 104 and contracts data database 105, respectively. The user may access the server 102 to obtain data from any of the databases 103 (e.g., previously registered current/proposed state analyses) and 104 (e.g., information regarding customer devices) without having to manually input the information. The server 102 is further described infra with reference to FIG. 2.

The customer devices database 103 may include information regarding a fleet of devices (e.g., printer, MFP, scanner, facsimile machine, etc.) for each customer. In other words, each customer may have an office, at a certain geographical location (e.g., city, town, etc.), that may include a fleet of devices. Information regarding each of the devices in the fleet of devices, such as name or identifier (e.g., device name, walkthrough ID, Asset tag, etc.), device type (e.g., printer, MFP, scanner, etc.), device functions (e.g., black & white, duplex, fax, scanning, N-up, etc.), physical location, network address (e.g., IP address, MAC address, etc.), output technology (e.g., laser, inkjet solid ink, thermal, other technology, etc.), supply level (e.g., level of consumable, such as paper and toner, is empty, low, ok, etc.), pages per job (e.g., 1, 2, 6-10, etc.), color technology (e.g., professional color, convenience color, etc.), device properties (e.g., manufacturer, model, serial number, etc.), etc. are stored in the customer devices database 103.

In another example, the customer device information in the customer devices database 103 may be in the form of a spreadsheet (e.g., Excel). In other words, the user may request from the customer information regarding the current fleet of devices of the customer by having the customer fill out an electronic spreadsheet with data (e.g., identifier, device type, functions, color technology, etc.) corresponding to each device. Such spreadsheet may be sent to the user electronically (e.g., e-mail), after which, the spreadsheet is stored in the customer devices database 103.

The state analysis database 104 registers any of various state analyses previously created. For example, the state analysis database 104 may include current state analyses corresponding to one or more customers and/or previously created proposed analyses. The database does not necessarily link a proposed state analysis to a particular customer. In other words, a proposed state analysis may be created in future anticipation of a type of customer. For example, the company that the user works for may have a specific proposed state analysis which includes one or more recently created products (to be used together) that are designed for companies in the information technology (IT) industry. However, the company employing the user may not yet have any customers from the IT industry. As a result, there is no company linked with the specific proposed state analysis. When the device and service management application 101a receives instructions to create a proposed state analysis, the device and service management application 101a may request access to the state analysis database 104 from the server 102 for the purpose of obtaining an existing current/proposed state analysis.

The contracts database 105 includes information regarding contracts of one or more customers. Any of such customer contracts may limit the devices that may be deployed for the customer to device models that are indicated in the contract.

The network 107 can be a local area network, a wide area network or any type of network such as an intranet, an extranet (for example, to provide controlled access to external users, for example through the Internet), a private or public cloud network, the Internet, etc., or a combination thereof. Further, other communications links (such as a virtual private network, a wireless link, etc.) may be used as well for the network 106. In addition, the network 106 preferably uses TCP/IP (Transmission Control Protocol/Internet Protocol), but other protocols such as SNMP (Simple Network Management Protocol) and HTTP (Hypertext Transfer Protocol) can also be used. How devices can connect to and communicate over networks is well-known in the art and is discussed for example, in “How Networks Work”, by Frank J. Derfler, Jr. and Les Freed (Que Corporation 2000) and “How Computers Work”, by Ron White, (Que Corporation 1999), the entire contents of each of which are incorporated herein by reference.

FIG. 1B shows schematically a system 100B, according to another exemplary embodiment. The system 100B is similar to the system 100A of FIG. 1A except that the system additionally includes a third party source 106.

The third party source database 106 may be databases maintained by any number of third party entities. Further, there may more than one third party source database connected to the network 107. For example, the third party source database may be maintained by an organization such as a device manufacturer, a commercial company or an online retailer. Each of the aforementioned organizations may register data regarding device models that are available on the market. In the case that the user of the terminal 101 attempts to determine the current state of the customer, such as by accessing a spreadsheet sent by the customer, the user may discover that the spreadsheet is missing certain information (e.g., price, functions, monthly volume, energy usage, etc.). The device and service management application 101a may automatically communicate with the third party source database 105 to obtain the missing device information and complete the spreadsheet.

Otherwise, operations of the elements of the system 100B are similar to those discussed in connection with the corresponding elements of the system 100A of FIG. 1A.

FIG. 2 shows an exemplary constitution of a computing device that can be configured (for example, through software) to operate (at least in part) as the terminal apparatus (e.g., 101 in FIGS. 1A and 1B) or a server (e.g., 102 in FIGS. 1A and 1B) or a host for database (e.g., 104 and 105 in FIGS. 1A and 1B; 106 in FIG. 1B).

In FIG. 2, apparatus 200 includes a processor (or central processing unit) 202 that communicates with a number of other components, including memory or storage device 203, other input/output (e.g., 10 keyboard, mouse, etc.) 204, display 205 and network interface 206, by way of a system bus 201. The apparatus 200 may be a special-purpose device (such as including one or more application specific integrated circuits or an appropriate network of conventional component circuits) or it may be software-configured on a conventional personal computer or computer workstation with sufficient memory, processing and communication capabilities to operate as a terminal and/or server, as should be appreciated by those skilled in the relevant art. In the apparatus 200, the processor 202 executes program code instructions that control device operations. The processor 202, memory/storage 203, input/output 204, display 205 and network interface 206 are conventional, and therefore in order to avoid obfuscating the inventive aspects of this disclosure, such conventional aspects are not discussed in detail herein.

The apparatus 200 includes the network interface 206 for communications through a network, such as communications through the network 107. However, it should be appreciated that the subject matter of this disclosure is not limited to such configuration. For example, the apparatus 200 may communicate with user terminals through direct connections and/or through a network to which some components are not connected. As another example, the apparatus 200 does not need to be provided as a server that services terminals, but rather may communicate with the devices on a peer basis, or in another fashion.

The apparatus 200 of the present disclosure is not limited to a server or computer, but can be manifested in any of various devices that can be configured to communicate over a network and/or the Internet.

An exemplary constitution of the client device 101 of FIGS. 1A and 1B is shown schematically in FIG. 3. In FIG. 3, apparatus 300 includes a processor (or central processing unit) 302 that communicates with various other components, such as memory (and/or other storage device) 303, display 304, application software 305, input/output (such as keyboard, mouse, touchpad, stylus, microphone and/or speaker with voice/speech interface and/or recognition software, etc.) 306 and network interface 307, by way of an internal bus 301.

The memory 303 can provide storage for program and data, and may include a combination of assorted conventional storage devices such as buffers, registers and memories [for example, read-only memory (ROM), programmable ROM (PROM), erasable PROM (EPROM), electrically erasable PROM (EEPROM), static random access memory (SRAM), dynamic random access memory (DRAM), non-volatile random access memory (NOVRAM), etc.].

The network interface 307 provides a connection (for example, by way of an Ethernet connection or other network connection which supports any desired network protocol such as, but not limited to TCP/IP, IPX, IPX/SPX, NetBEUI, etc.) to the network to which the computer 300 is connected (e.g., network 107 of FIG. 1).

Additional aspects or components of the terminal apparatus 300 are conventional (unless otherwise discussed herein), and in the interest of clarity and brevity are not discussed in detail herein. Such aspects and components are discussed, for example, in

“How Computers Work”, by Ron White (Que Corporation 1999), and “How Networks Work”, by Frank J. Derfler, Jr. and Les Freed (Que Corporation 2000), the entire contents of each of which are incorporated herein by reference.

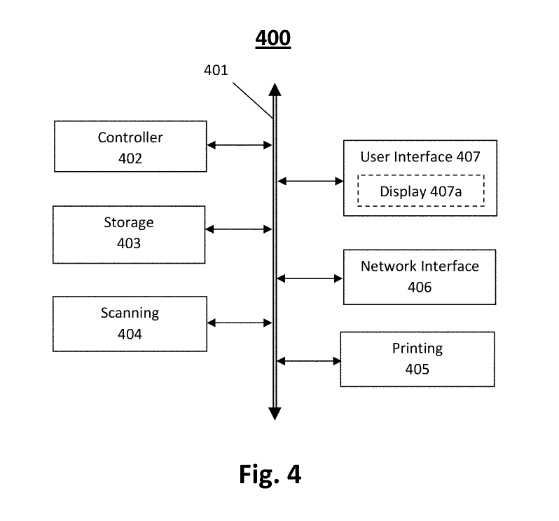

FIG. 4 shows a schematic diagram of a configuration of an output device as an MFP (multi-function printer or multi-function peripheral) device. The output device 400 shown in FIG. 4 includes a controller 402, and various elements connected to the controller 402 by an internal bus 401. The controller 402 controls and monitors operations of the output device 400. The elements connected to the controller 402 include storage 403 (for example, random access memory, read-only memory, hard disk drive, portable storage media drive such as for optical discs, magnetic discs, magneto optical discs, etc., semiconductor memory cards, combinations of storage media, etc.), scanning 404, printing 405, a network interface (I/F) 406, a user interface 407.

Storage 403 can include one or more storage parts or devices [e.g., a read only memory (for example, ROM, PROM, EPROM, EEPROM, etc.), a random access memory (RAM), a hard disk drive (HDD), portable media (for example, floppy disk, optical disc, magnetic discs, magneto-optical discs, semiconductor memory cards, etc.) drives], and program code instructions can be stored in one or more parts or devices of storage 403 and executed by the controller 402 to carry out the instructions. Such instructions can include instructions for performing specified functions (such as printing, scanning, faxing, copying, e-mailing, etc.) of the output device 400, to enable the output device 400 to interact with a terminal, as well as perhaps other external devices, through the network interface 406, and interactions with users through the user interface 407.

The network interface 406 is utilized by the output device 400 to communicate via a network with other network-connected devices such as a terminal, a server and receive data requests, print (or other) jobs, user interfaces, and etc.

The user interface 407 includes one or more electronic visual displays that display, under control of controller 402, information allowing the user of the output device 400 to interact with the output device 400. The electronic visual display can be any of various conventional displays (such as a liquid crystal display, a plasma display device, a cathode ray tube display, etc.), but preferably is equipped with a touch sensitive display (for example, liquid crystal display) and is configured to provide a GUI (graphical user interface) based on information input by an operator of the output device 400, so as to allow the operator to interact conveniently with services provided on the output device 400, or with the output device 400 serving as terminal for accessing electronic data or other content through the network. User interfaces or other contents received through the network via the network interface 406 can be displayed on the display screen.

The display screen does not need to be integral with, or embedded in, a housing of the output device 400, but may simply be coupled to the output device 400 by either a wire or a wireless connection. The user interface 407 may include keys and/or buttons (such as graphical keys or buttons, or other graphical elements, of a GUI on a touchscreen display 407a) for inputting information or requesting various operations. Alternatively, the user interface 407 and the display screen may be operated by a keyboard, a mouse, a remote control, voice recognition, or eye-5 movement tracking, or a combination thereof.

Scanning 404, printing 405, and network interface 406 are otherwise conventional, and therefore, a detailed description of such conventional aspects is omitted in the interest of clarity and brevity. The output device 400 can have any or all of the functions of similar devices conventionally known, such as for scanning, editing and storing images, sending a fax, sending and receiving e-mails with or without attachments, accessing files by FTP or another protocol or facility, surfing the Web, scan-to-folder, scan-to-email, etc.

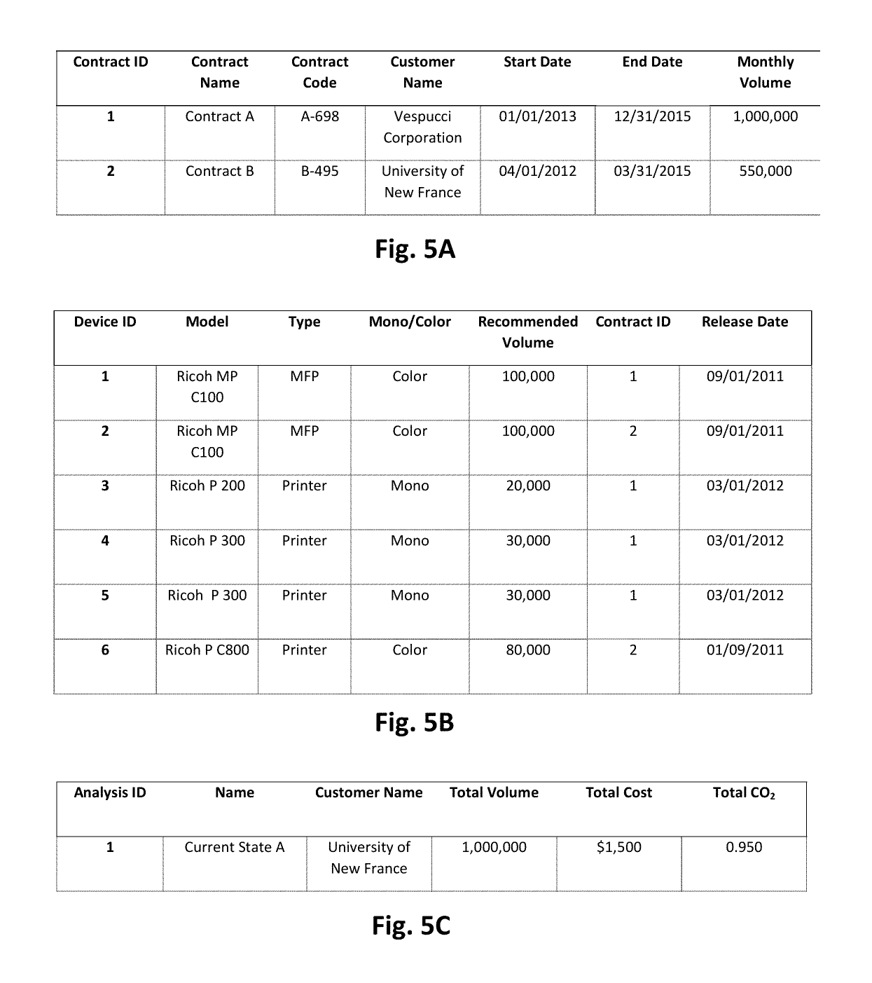

FIG. 5A shows an example of a contract table stored in a contracts database (e.g., 105) that includes contracts to supply devices and services to respective customer. Each contract may be identified by one or more contract identifiers (e.g., Contract ID, Contract Name, Contract Code). Further, the start date and termination date of each contract is shown as well. In addition, the monthly volume associated with each contract is registered.

FIG. 5B shows an example of a contract model table stored in a contracts database (e.g., 105) that includes devices models that are to be provided or supported, under the associated contract (identified by contract ID). In such table, selected device properties (e.g., device type, mono-color capability, and recommended volume) may be shown for each device model.

FIG. 5C shows an example of an analysis table stored in a state analysis database (e.g., 104; or alternatively, in the contract database) that includes all analyses that have ever been performed.

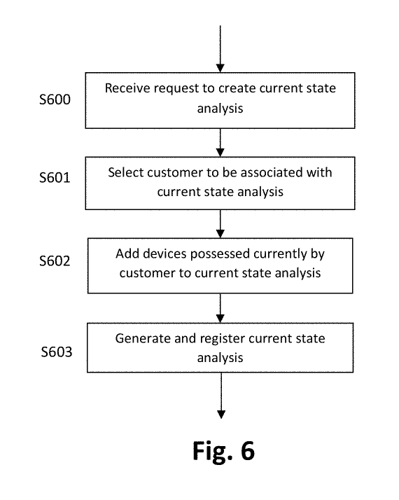

FIG. 6 shows a method that can be performed by or with a device and service management application (e.g., 101a) on a terminal apparatus (e.g., 101), according to an exemplary embodiment.

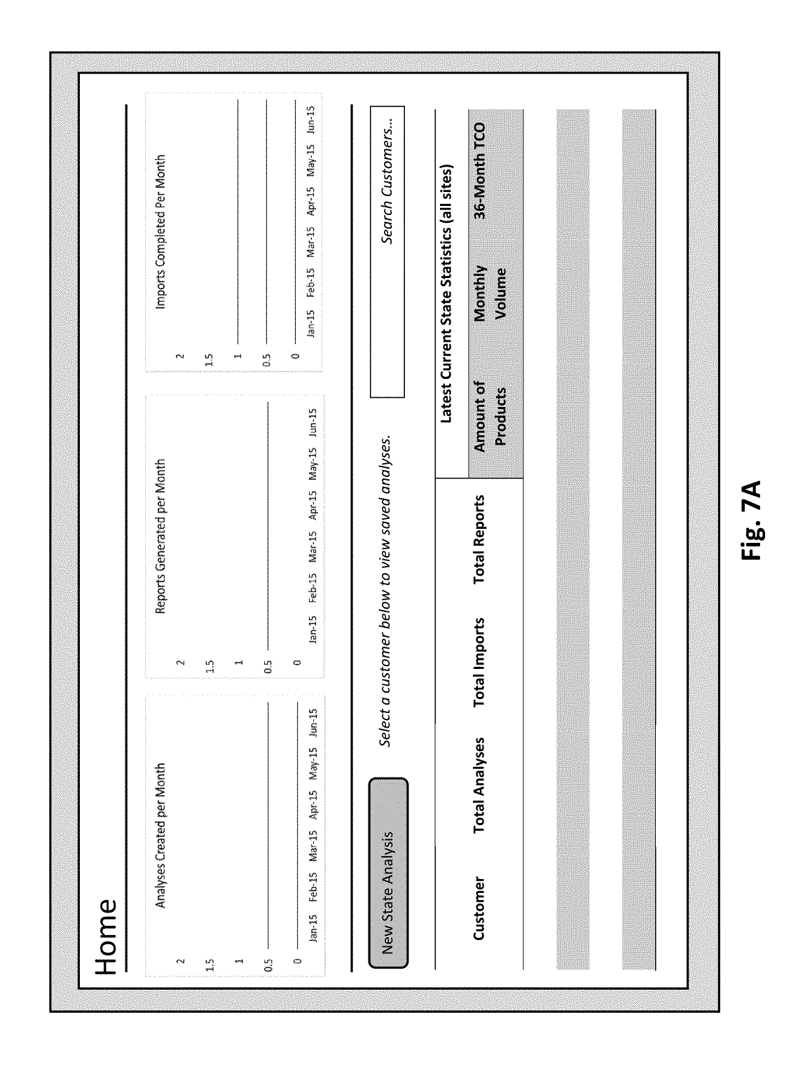

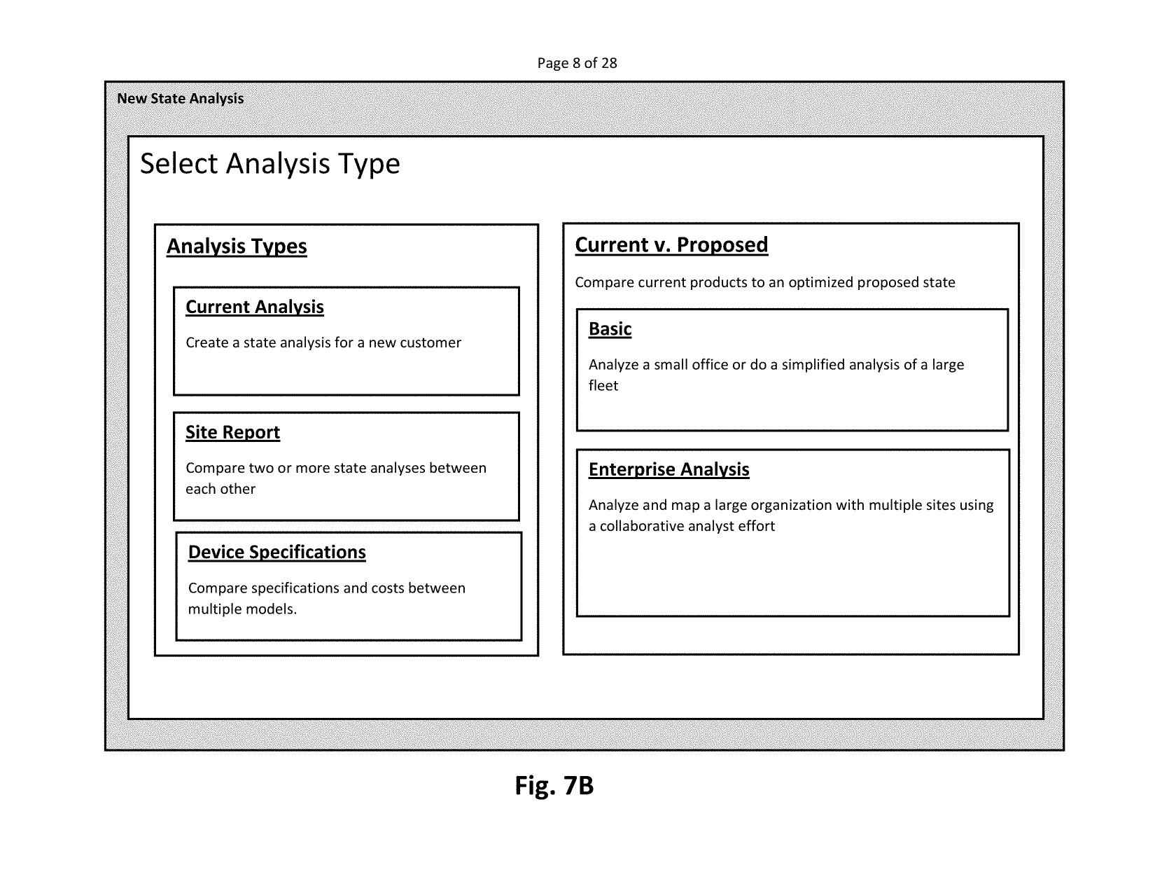

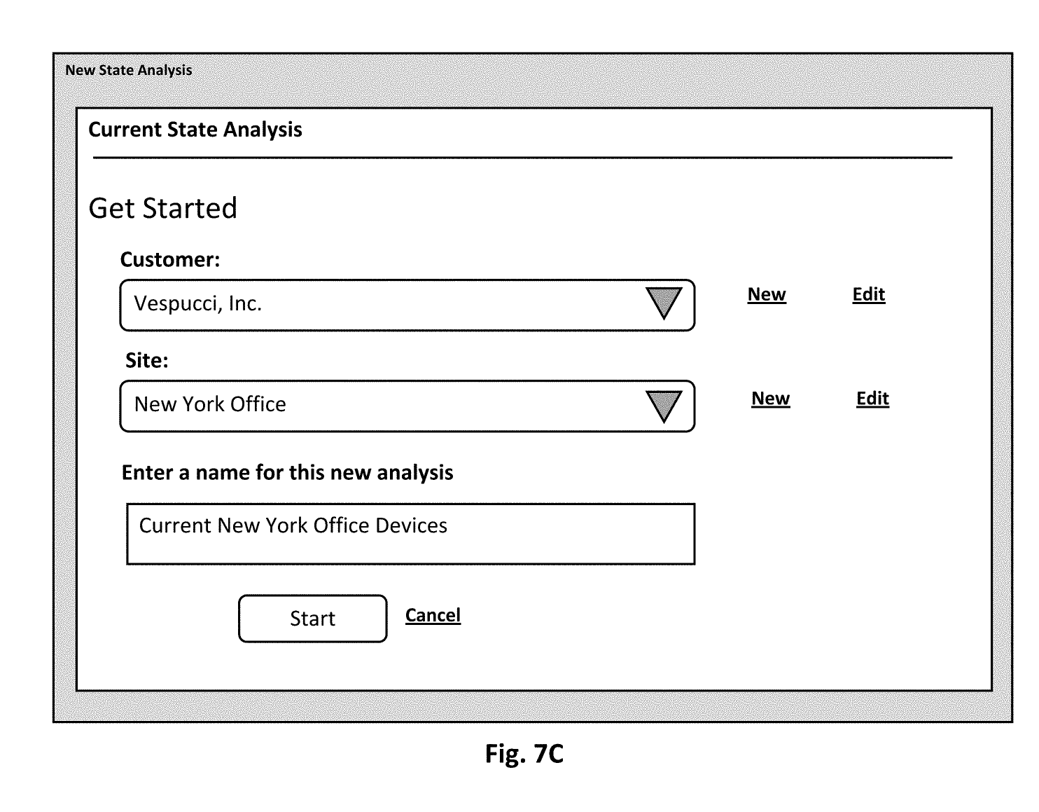

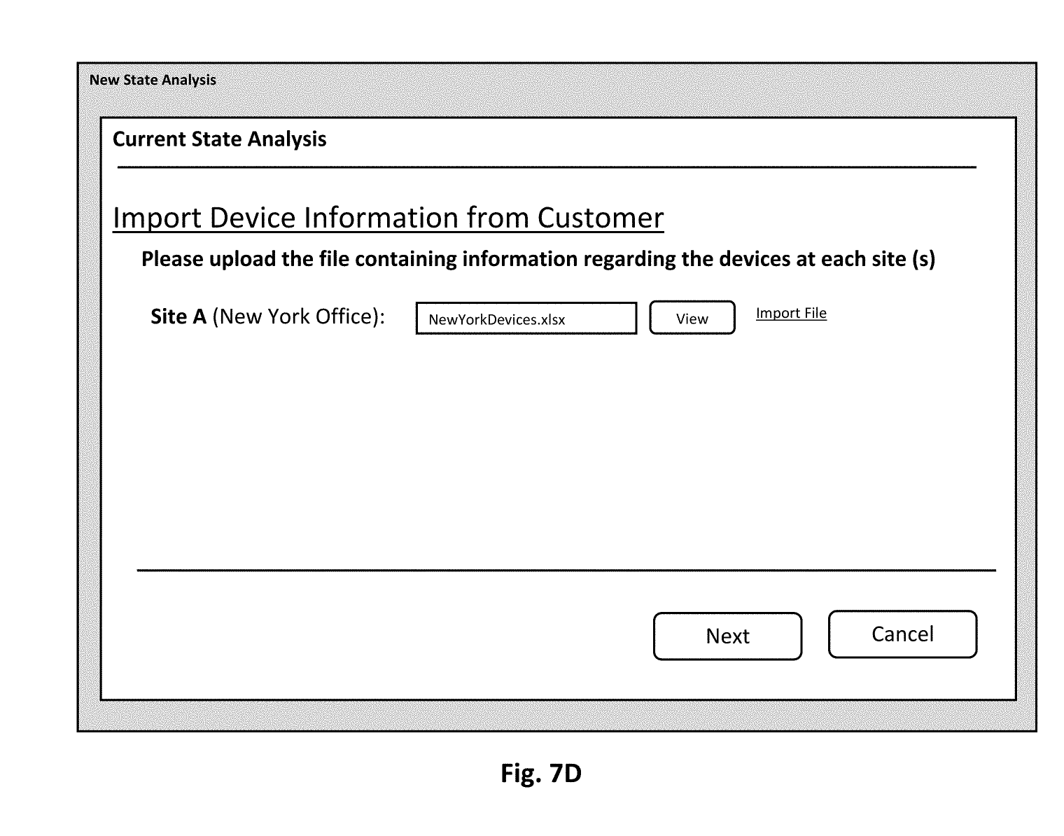

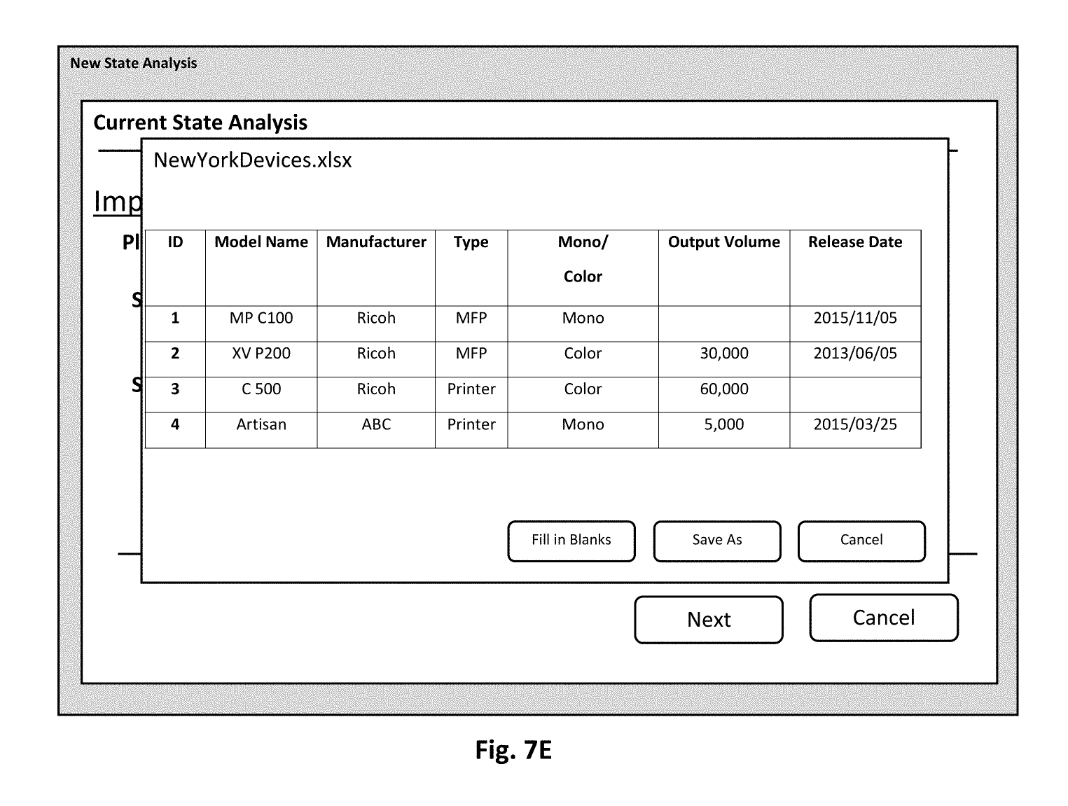

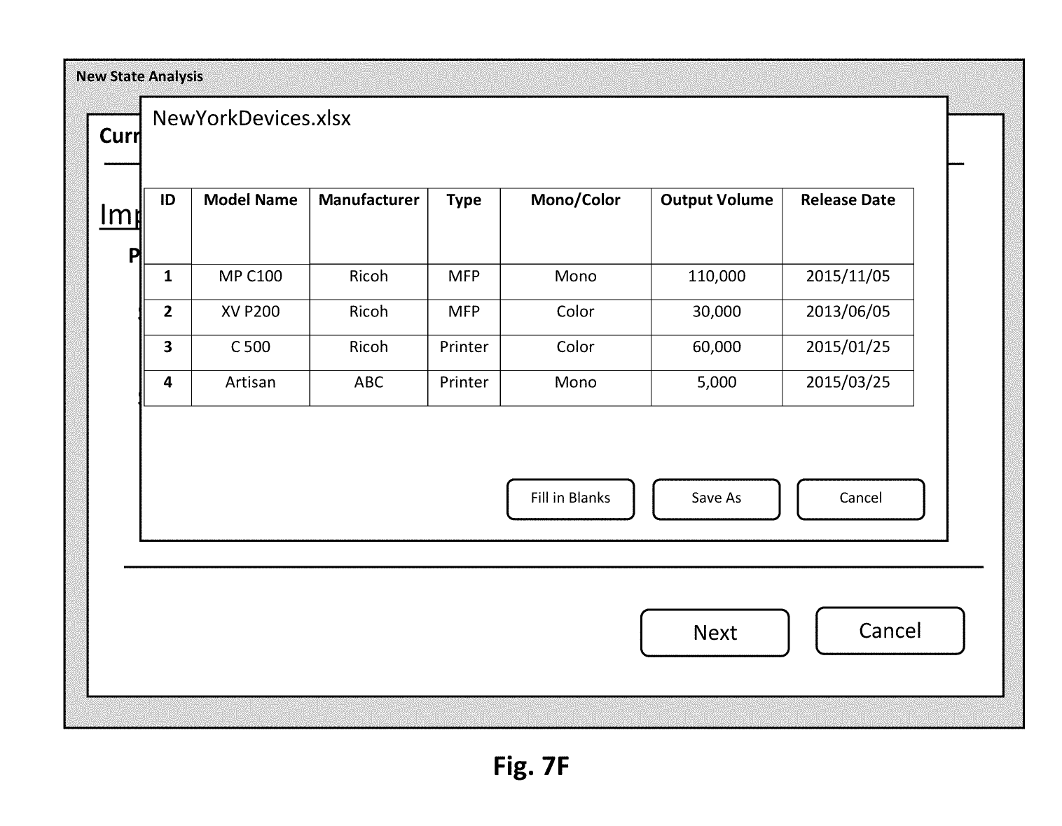

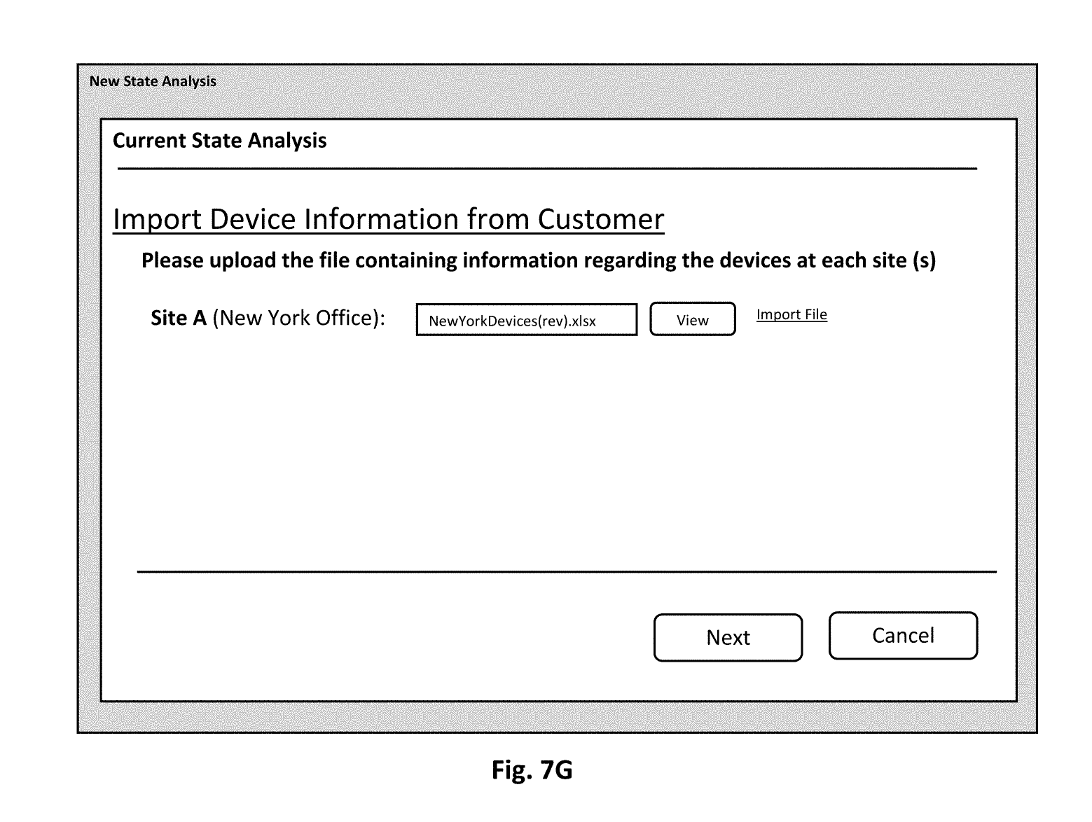

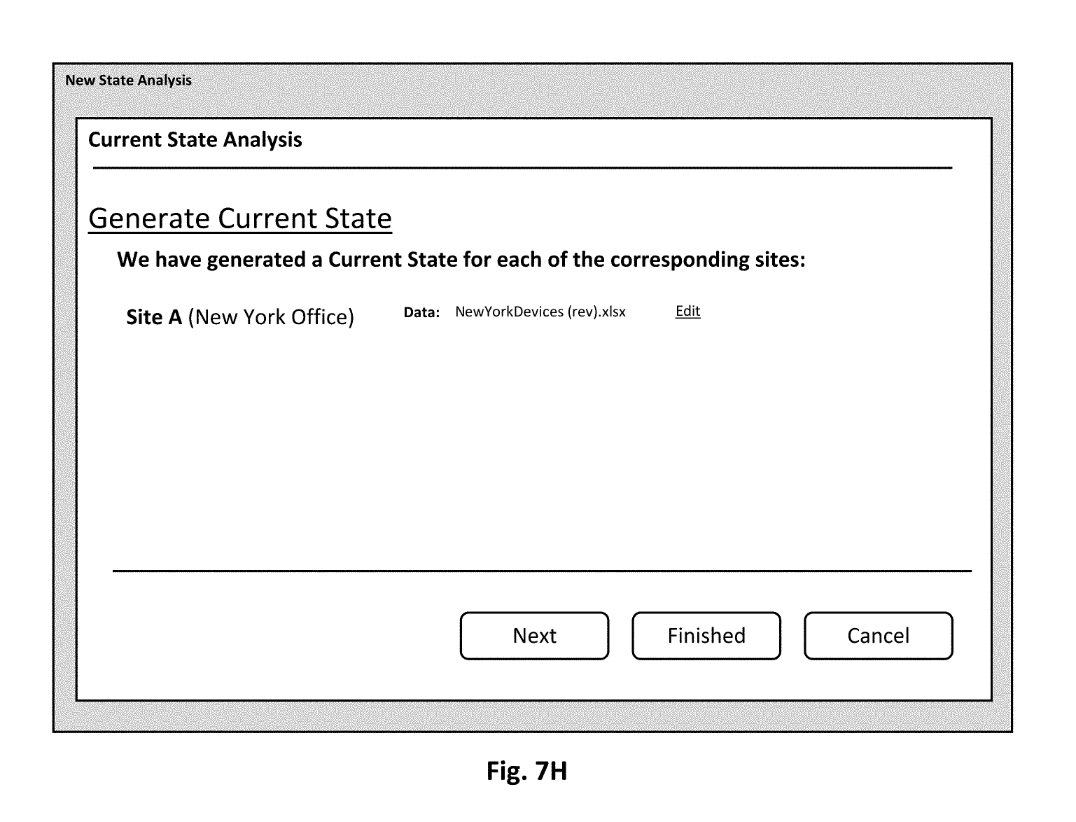

In an example of a workflow discussed below with reference to FIG. 7A through FIG. 7H, a manager of the customer Vespucci, Inc. determines that an existing contract (i.e. current contract) with vendor Ricoh will expire soon. The manager determines that he wants to try to renew or create a new contract with Ricoh, starting off with the New York office of Vespucci, Inc., and therefore the manager contacts Ricoh and asks whether there are any new devices recently manufactured by Ricoh that could replace devices that are in the current contract since the manager thinks that one or more of the devices in the current contract are outdated. A Ricoh representative (herein “the user”) responds to the manager's inquiry and request information regarding what devices are currently employed at the New York office. The user sends a spreadsheet to the manager and asks him to fill out the spreadsheet with information regarding devices currently employed at the New York office. The user receives an e-mail from the manager which contains the completed spreadsheet that includes all of the information regarding the devices in the New York office. Thus, the user proceeds to create a profile for the New York office, by activating the “New State Analysis” button (S600), such as shown in FIG. 7A, and since the user is doing a current state analysis for Vespucci, he activates the “Current Analysis” button, such as shown in FIG. 7B.

Next, the user selects the customer (i.e. Vespucci, Inc.) and site (i.e. New York office) information from the drop down menu (step S601). Then, he activates the “Start” button, such as shown in FIG. 7C. After the user has activated the “Start” button, he can begin adding devices to the current state analysis of Vespucci (S602), such as by electronically uploading the spreadsheet received from the manager, such as shown in FIG. 7D. Further, the user may also view the file given to him by the manager, such as shown in FIG. 7E.

In the current instance, the file including the information of each device at a certain site (e.g., New York office) is not complete, as evident from the blank spaces in the spreadsheet shown in FIG. 7E.

When there is incomplete information in the table of devices, the user can complete the table by activating the “Fill in Blanks” button which causes the device and service management application to communicate with a third party source to obtain information that can complete the table. Once the table is completed, such as shown in FIG. 7F, the user can save the completed table by activating the “Save As” button which causes the file to be saved as “NewYorkDevices(rev).xlsx”, such as shown in FIG. 7G. Next, when the user activates the “Next” button, a current state analysis is generated for the New York office (S5603), such as shown in FIG. 7H.

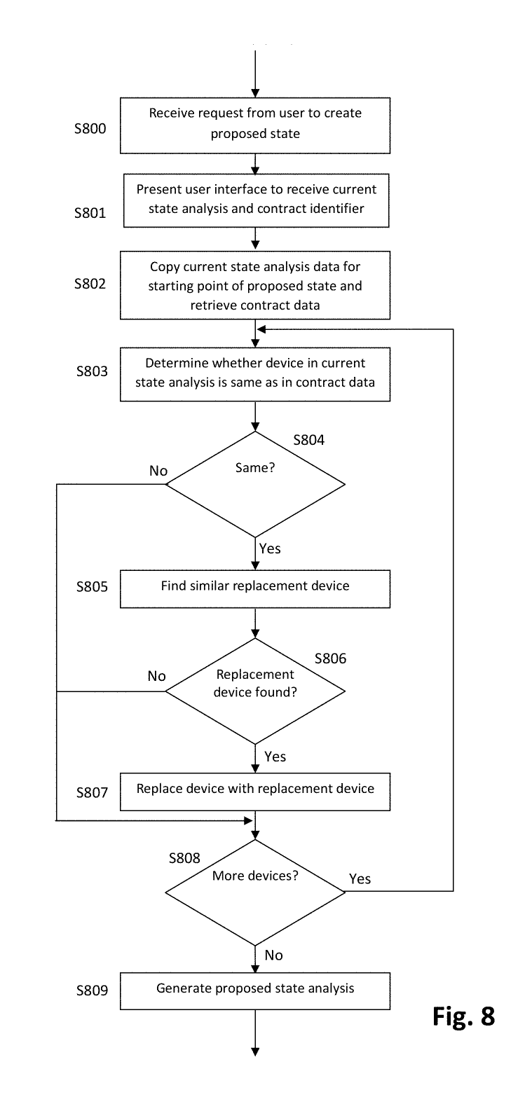

FIG. 8 show a method that can be performed by or with a device and service management application (e.g., 101a) on a terminal apparatus (e.g., 101), according to an exemplary embodiment.

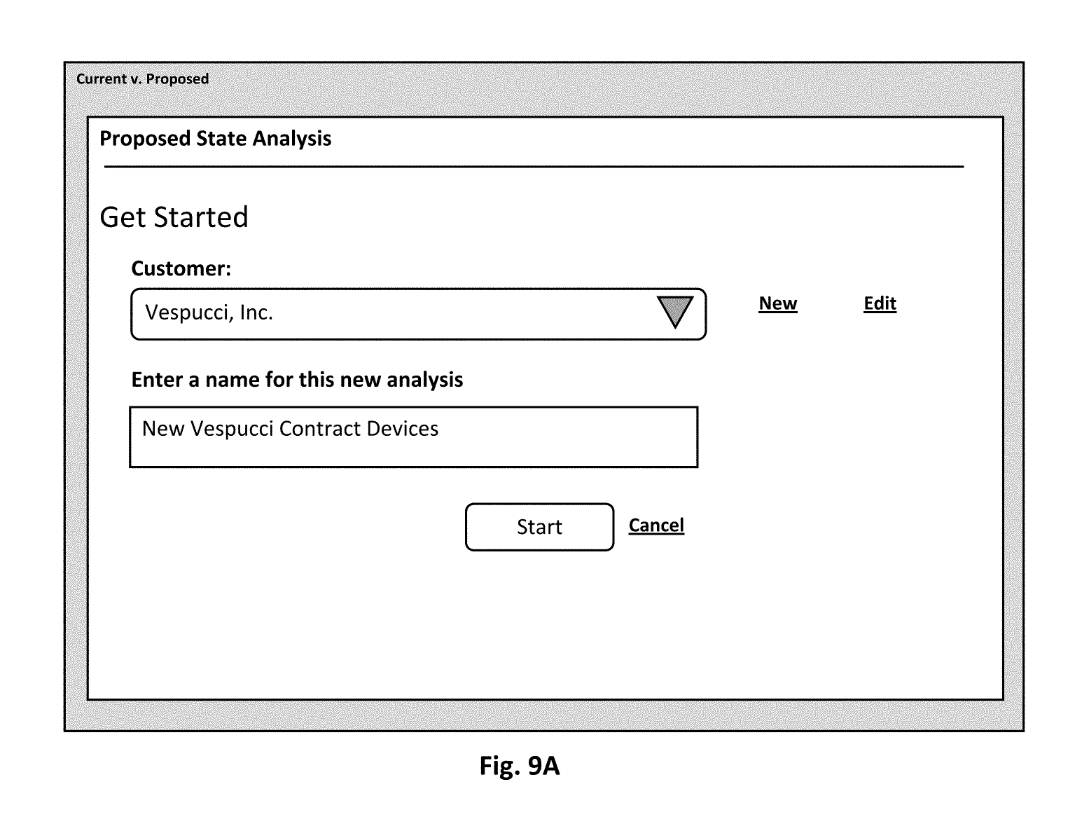

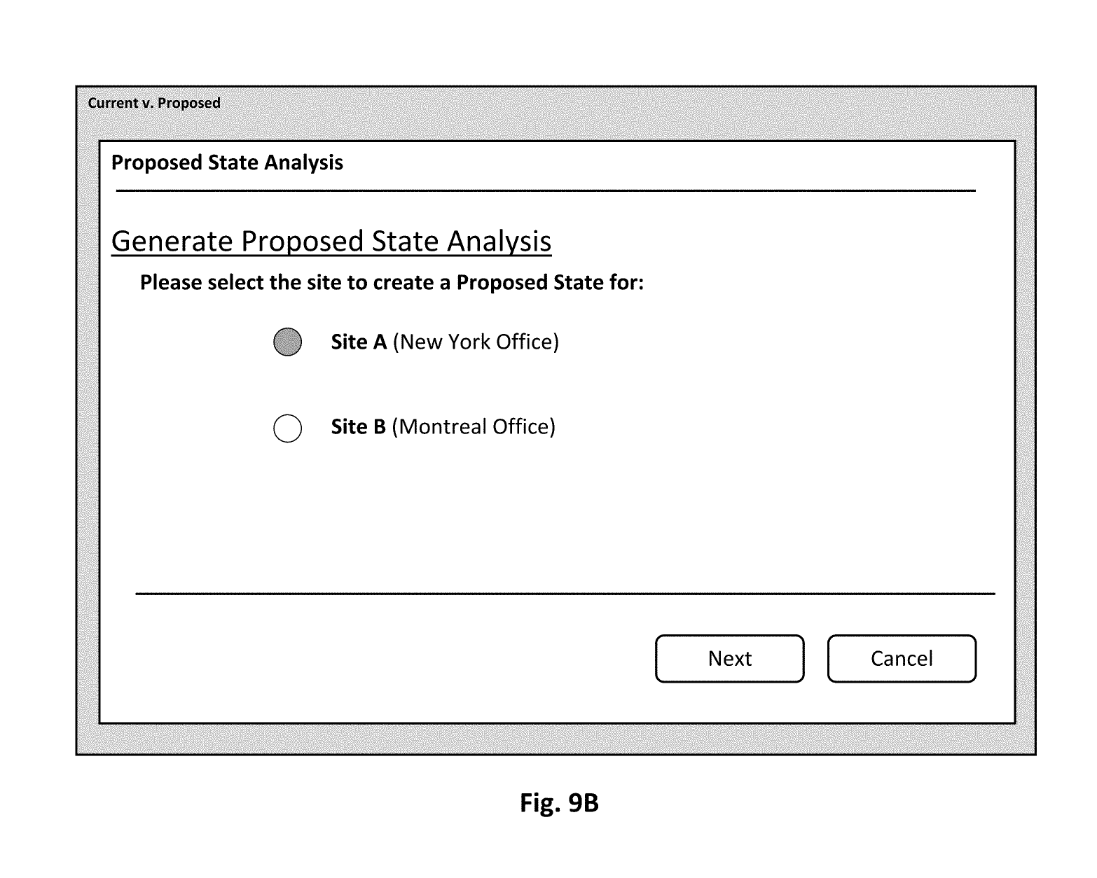

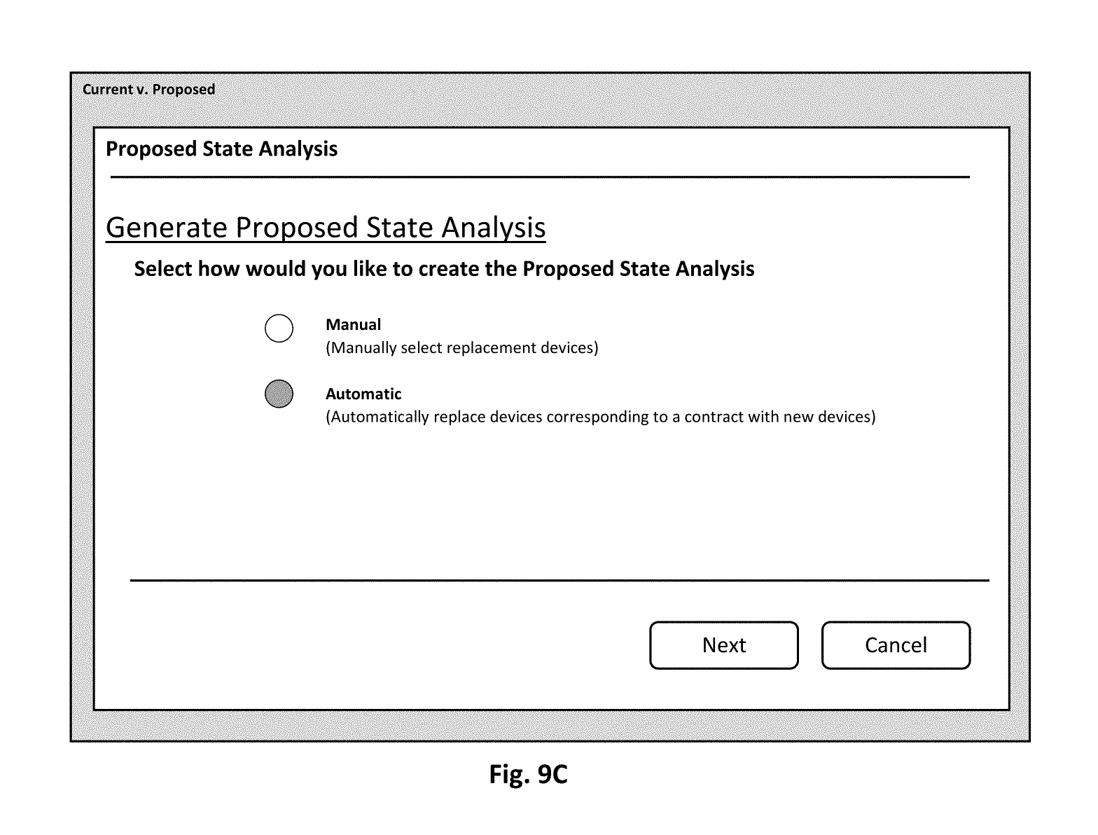

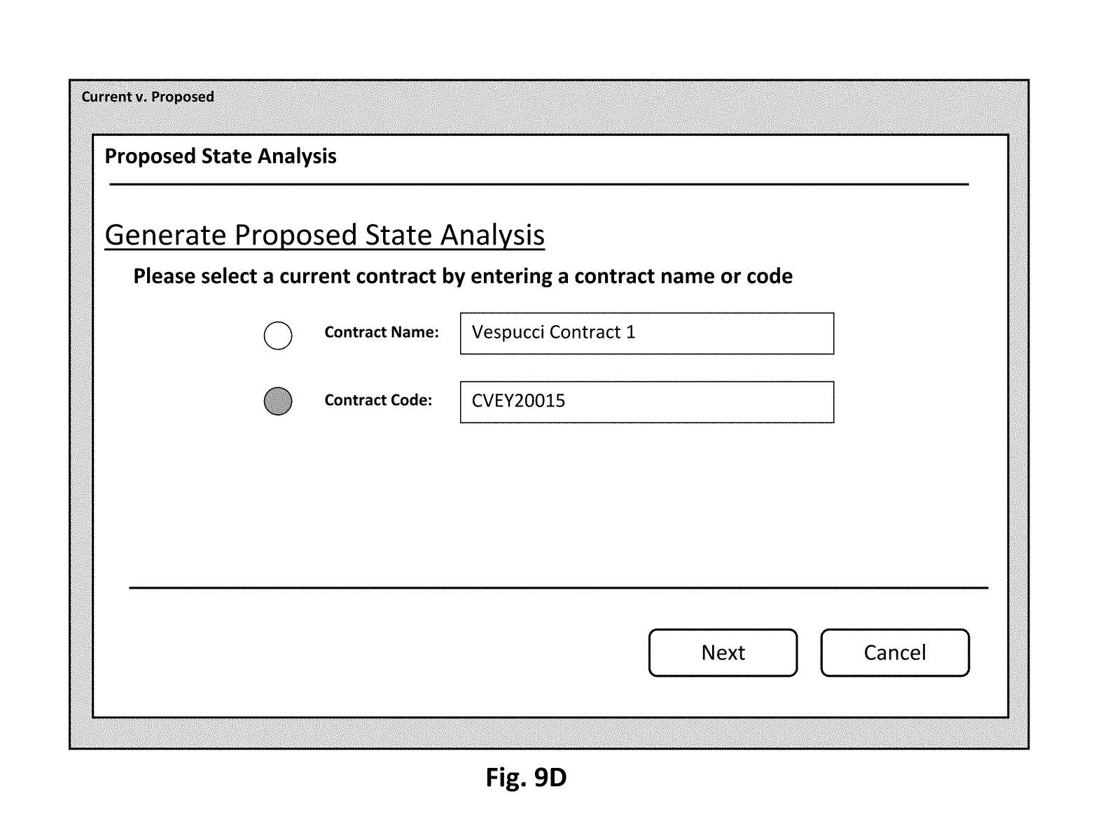

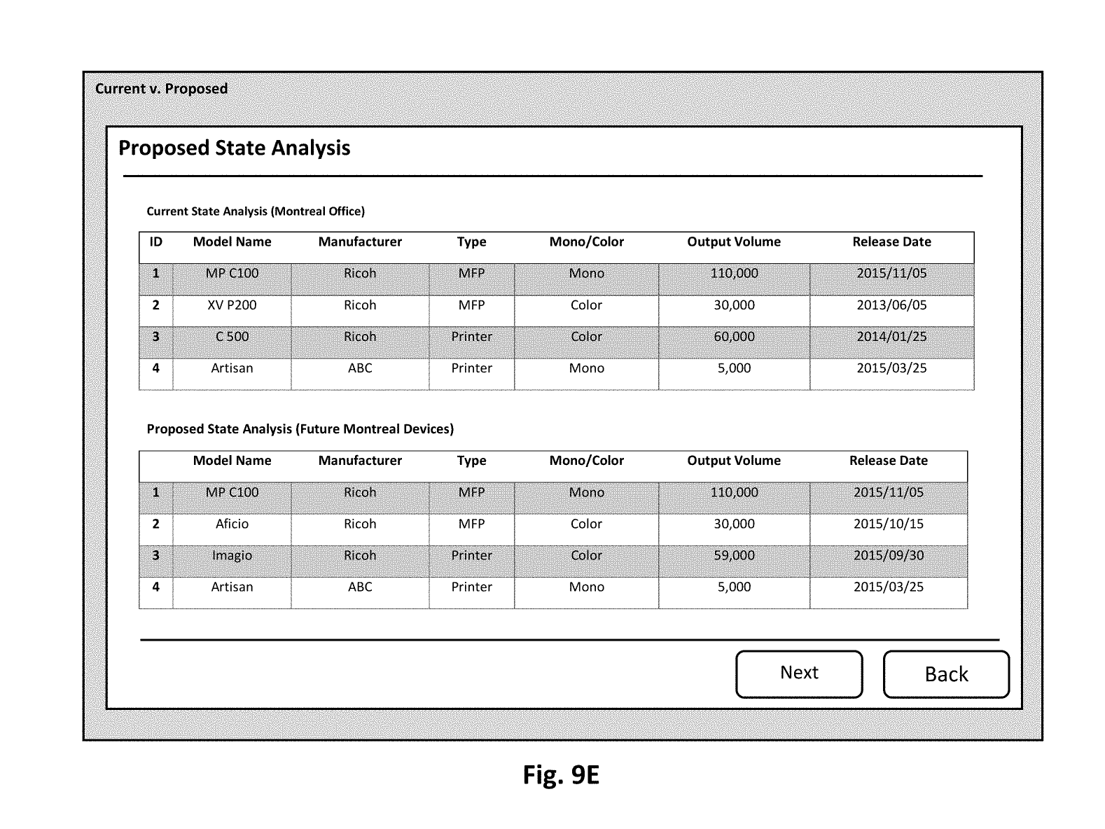

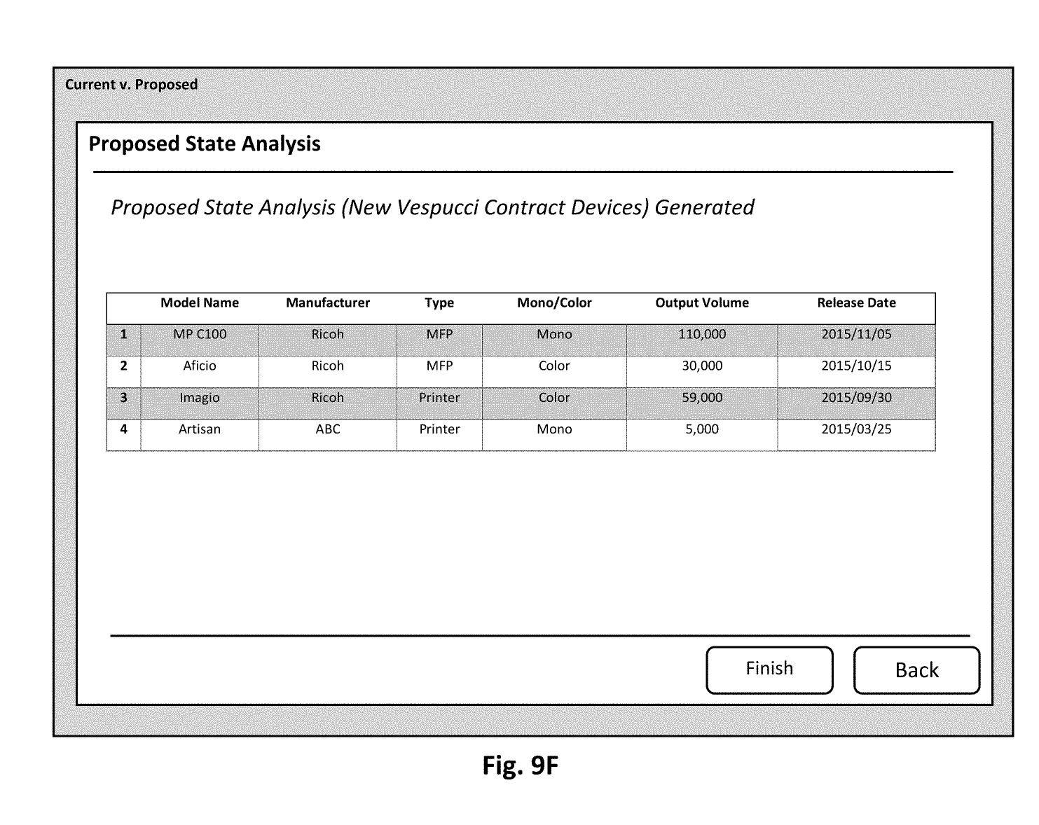

After creating the current state analysis, the user can now create a proposed state analysis by activating the “Basic” button (S700) as previously shown in FIG. 7B. Next, the user is prompted to select a customer (in this case, Vespucci, Inc.) and create a name for the proposed state analysis (in this case, New Vespucci Contract Devices), such as shown in FIG. 9A. Subsequently, device and service management application presents the user with a series of user interface screens to (i) select a current state analysis and (ii) enter a contract identifier (step S801). Such options to select a current state analysis (e.g., “Site A” and “Site B”) are shown in FIG. 9B. In this case, since the manager asked Ricoh for a proposed state analysis corresponding to the New York office, the user selects the “Site A” option.

Next, the device and service management application presents to the user a screen for selecting a method (i.e. automatic or manual) to perform a proposed state analysis, such as shown in FIG. 9C. By selecting the manual option, the user can manually revise the current state analysis by adding, removing or editing the devices currently in the proposed state. On other hand, the user can select the automatic option in which the device and service management application generates automatically a proposed state analysis. In this case, the user has selected to permit the device and service management application to automatically generate a proposed state analysis.

After receiving the instruction from the user, the device and service management application prompts the user to enter a contract identifier in order to obtain existing contract data corresponding to Vespucci, such as shown in FIG. 9D. For example, the contract identifier may be a contract name (e.g., Vespucci Contract 1) input by a person (i.e. IT administrator, salesperson, manager, secretary, etc.). In another example, the contract identifier may be a contract code (CVEY20015) that is a series of number and/or letters assigned by a computer (or software).

Then, the device and service management application creates a copy of the current state analysis as a starting point for the proposed state, and retrieves contract data corresponding to the contract identifier input by the user (step S802). Next, the device and service management application determines whether the devices in the current state analysis selected by the user are also in the retrieved contract data (step S803). In other words, the device and service management application attempts to match the devices in the proposed state with the devices in the retrieved contract data (which in this case represents the current contract between Ricoh and Vespucci). In the case that there is a match (step S804, yes), the device and service management application tries to find a similar device (step S805).

In an exemplary embodiment, the device and service management application may try to find a device that (i) is the same device type, (ii) includes the same mono-color capability, (iii) and has the same recommended output volume. In another exemplary embodiment, the device and service management may additionally try to find a device that has a release date is more recent than the release date of the matched device. In yet another exemplary embodiment, the device and service management application may search for devices in a third-party source (e.g., 106).

In the case that a replacement is found (step S806, yes), the device and service management application replaces the matched device with the replacement device. Otherwise, in the case that (i) the device in the proposed state does not match any devices in the contract data (step S804, no) or (ii) there is not replacement device found (step S806, no), the device and service management application determines if more devices in the proposed state still need to be checked (step S808). In the case that there are more devices to be checked (step S808, yes), the process is repeated.

Otherwise, the device and service management application presents to the user the changes made to the proposed state, such as shown in FIG. 9E. In this case, (a) the devices “XV P200” and “C 500” were determined to be in the contract data and (b) there existed newer devices (i.e. “Aficio” and “Imagio”) which had similar properties (and had a more recent release date) to “XV P200” and “C 500”. Thus, “XV P200” and “C 500” were replaced by “Aficio” and “Imagio”, respectively. In addition, the device “MP C100” was not replaced because there was no newer device that had a release date that was more recent then the release date of “MP C100”. Further, “Artisan” was not replaced since it is from a different company and therefore not in Ricoh's contract with Vespucci.

After the user is satisfied, he can generate a proposed state analysis by activating the “Next” button which causes the device and service management application to generate the proposed state analysis (step S809), and the user is asked to confirm that such generation process is finished, such as shown in FIG. 9F.

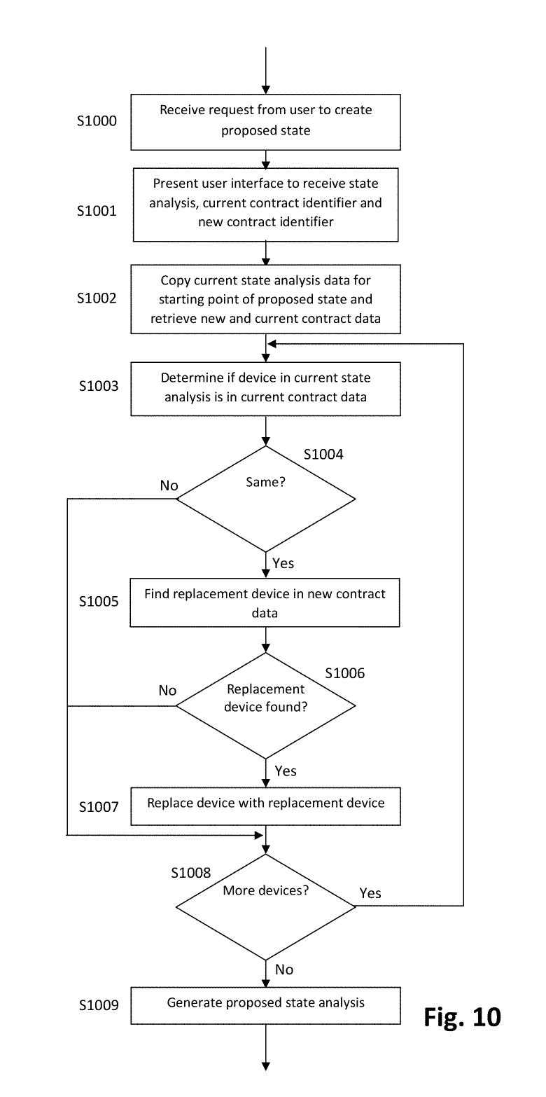

FIG. 10 show a method that can be performed by or with a device and service management application (e.g., 101a) on a terminal apparatus (e.g., 101), according to an exemplary embodiment.

In this case, there may be an existing (i.e. current) contract and a new contract. For example, Vespucci may have a current contract with Ricoh for the Montreal office that is close to expiring, and therefore Vespucci and Ricoh proceed to execute a new contract. The current contract remains in effect pending, while the new contract (although formed) is yet to commence. Nevertheless, the manager requests a proposed state analysis under the new contract (when it comes into effect). That is, the devices currently employed at the Montreal office under the current contract are to be (if possible) replaced with new devices under the new contract.

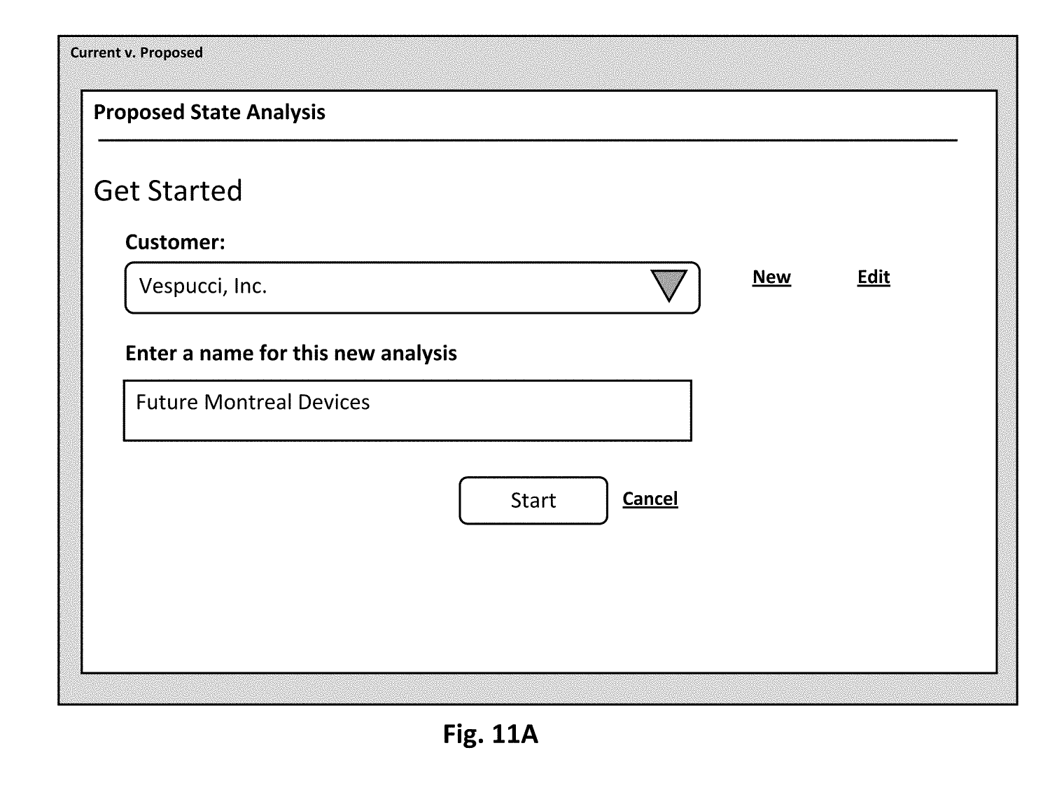

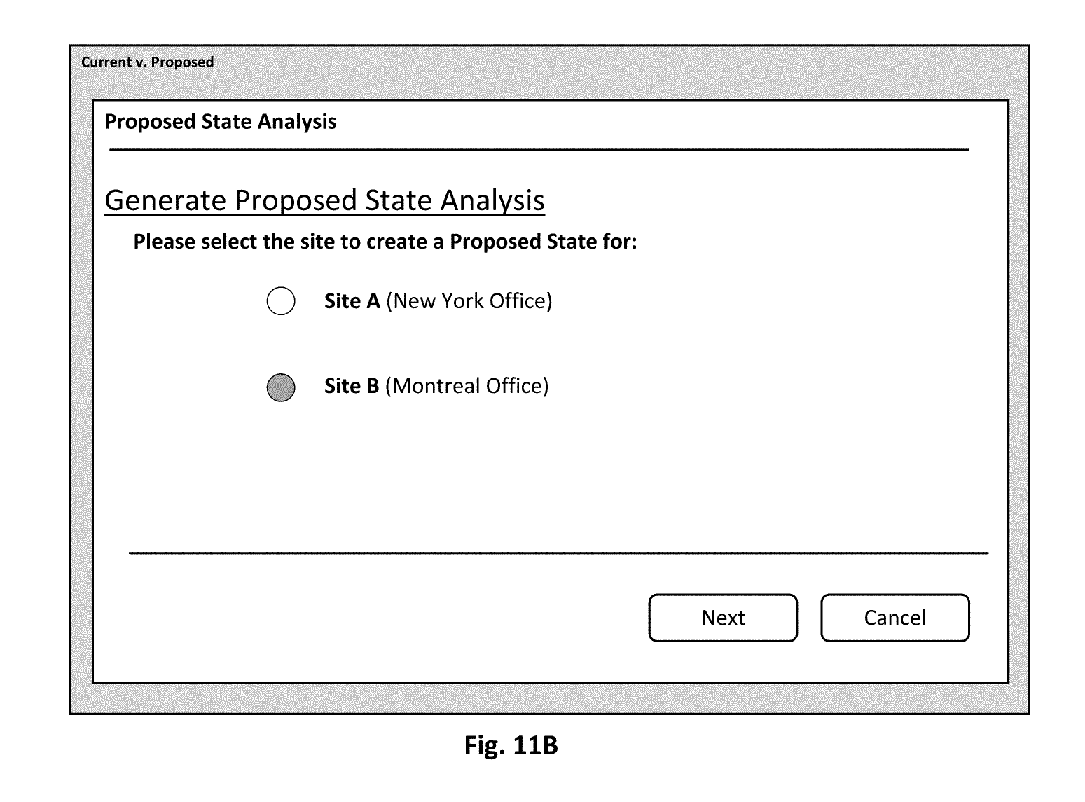

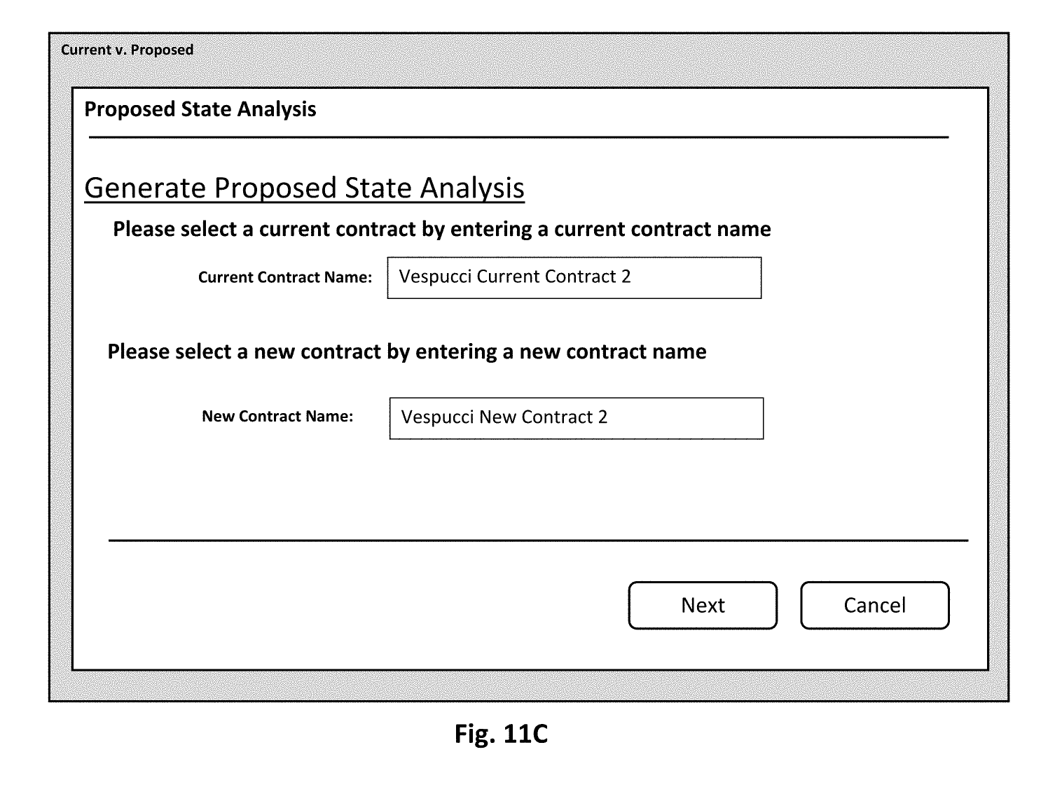

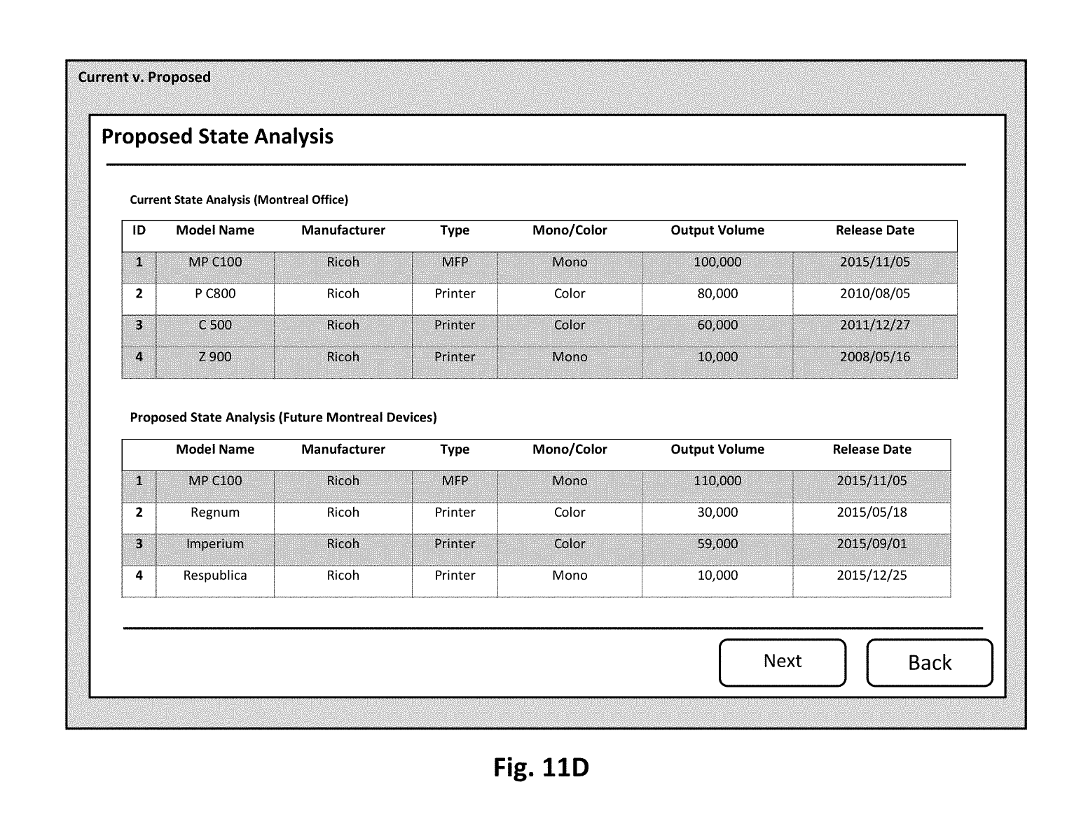

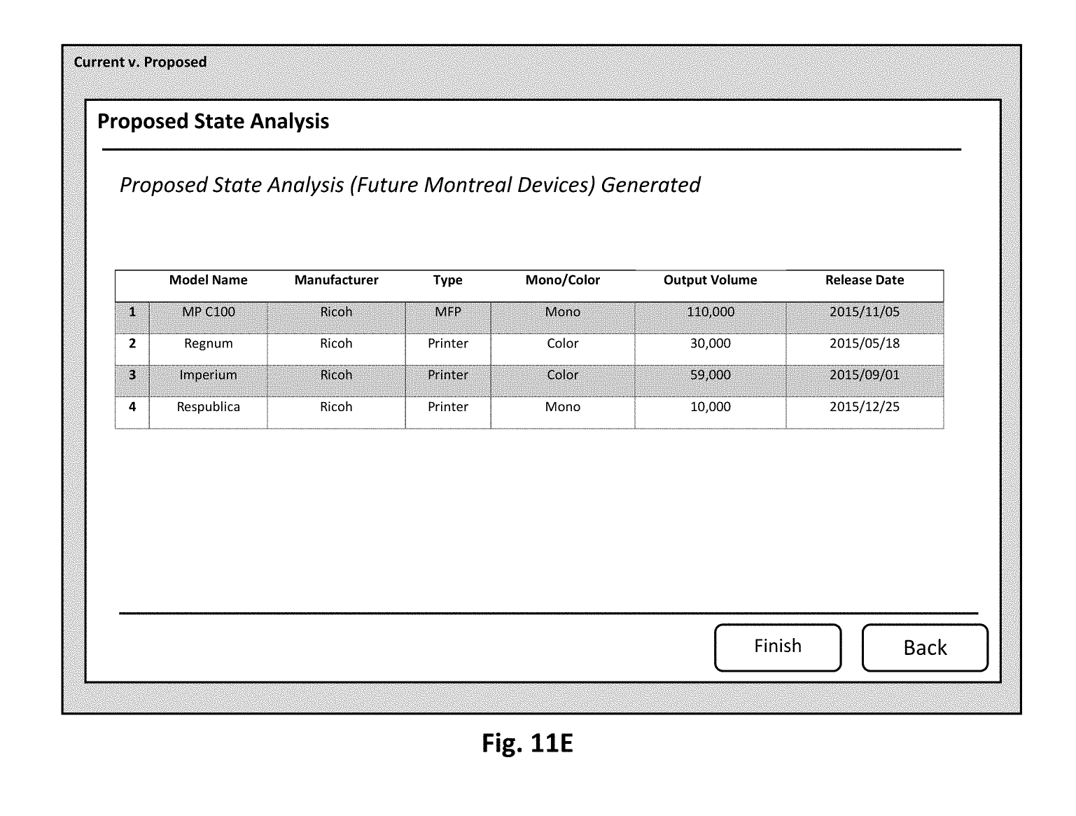

Thus, the user proceeds to create a proposed state analysis by activating the “Basic” button (S1000), such as shown in FIG. 7B. Next, the user is prompted to select a customer (in this case, Vespucci, Inc.) and create a name for the proposed state analysis (in this case, Future Montreal Devices), such as shown in FIG. 11A. Subsequently, the device management application presents the user with a series of user interface screens to (i) select a current state analysis, (ii) enter a current contract identifier and (iii) enter a new contract identifier (step S1001). Such options to select a current state analysis (e.g., “Site A” and “Site B”) are shown in FIGS. 11B-11C.

Next, the device management application prompts the user to enter a contract identifier in order to obtain existing contract data corresponding to the Montreal office, such as shown in FIG. 11C. In this case, the user enters the contract identifier for both the current contract (Vespucci Current Contract 2) and the new contract (Vespucci New Contract 2). Then, the device and service management application creates a copy of the current state analysis as a starting point for the proposed state, and retrieves contract data corresponding to the new and current contract identifier input by the user (step S1002).

The device and service management application then determines whether the devices in the current state analysis selected by the user are also in the current contract data (step S1003). In other words, the device and service management application attempts to match the devices in the copy of the current state analysis with the devices in the retrieved current contract data. In the case that there is a match (step S1004, yes), the device and service management application access (i) the retrieved new contract data and (ii) searches for a replacement device in the new contract data (step S1005).

In an exemplary embodiment, the device and service management application may try to find a device that (i) is the same device type, (ii) includes the same mono-color capability, (iii) and has the same recommended output volume. In another exemplary embodiment, the device and service management may additionally try to find a device that has a release date that is more recent than the release date of the matched device. In yet another exemplary embodiment, the device and service management application may search for devices in a third-party source (e.g., 106).

In the case that a replacement is found (step S1006, yes), the device and service management application replaces the matched device with the replacement device. Otherwise, in the case that (i) the device in the proposed state does not match any devices in the contract data (step S1004, no) or (ii) there is not a replacement device found (step S1006, no), the device and service management application determines if more devices in the proposed state still need to be checked (step S1008). In the case that there are more devices to be checked (step S1008, yes), the process is repeated.

Otherwise, the device and service management application presents to the user the changes made to the proposed state, such as shown in FIG. 11D. In this case, (a) the devices “P C800”, “C 500” and “Z 900” were determined to be in the current contract data and (b) there existed newer devices (i.e. “Regnum”, “Imperium”, “Respublica”) that could replace them. On the other hand, the device “MP C100” was not replaced because there was no newer device that had a release date that was more recent then the release date of “MP C100” in the new contract.

After the user is satisfied, he can generate a proposed state analysis by activating the “Next” button which causes the device and service management application to generate and store the proposed state analysis (step S1009), and the user is asked to confirm that such generation process is finished, such as shown in FIG. 11E.

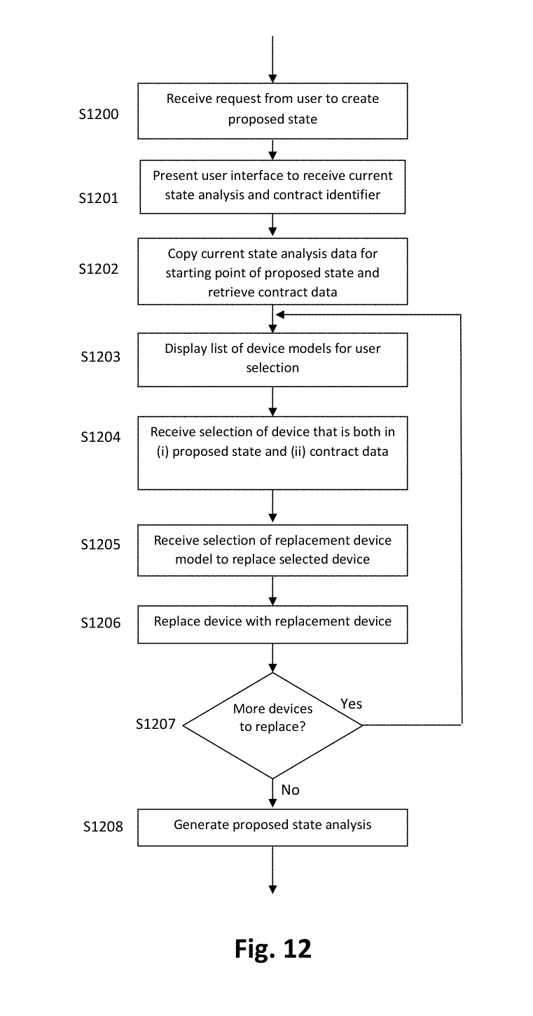

FIG. 12 shows a method that can be performed by or with a device and service management application (e.g., 101a) on a terminal apparatus (e.g., 101), according to an exemplary embodiment.

In this case, it is not required that the user automatically replace devices in the proposed state to generate a proposed state analysis. In other words, the user can select which devices to replace. Such process begins when the device and service management application receives an instruction from the user to generate a proposed state analysis (step S1200). Next, the device and service management application presents an interface to receive a specific current state analysis from the user and a contract identifier (step S1201). Then, the device and service management application creates a copy of the selected current state analysis and retrieves contract data corresponding to the contract identifier entered by the user (step S1202).

Afterwards, the device and service management application presents a list of device models to the user (step S1203). In one exemplary embodiment, the device models may come from a device database or a third-party source. In another exemplary embodiment, the device models may come from another contract. Subsequently, device and service management application receive selection from the user of a specific device that is both in (i) copy of current state analysis and (ii) the retrieved contract data (step S1204). Further, the device and service management application also receives a selection of replacement device to replace the specific device from the device models list (step S1205). Next, the device and service management application replaces the specific device with the replacement device (step S1206).

Then, the device and service management application determines if the user wishes to replace any more devices (step S1207). If he does (step S1207, yes), the process repeats. Otherwise (step S1207, no), the proposed state analysis is generated from the modified copy of current state analysis (step S1208).

The orders in which the steps are performed in the aforementioned methods are not limited to those shown in the examples of FIGS. 6, 8, 10 and 12, and may be switched as long as similar results are achieved. Also, it should be noted that the methods illustrated in the examples of FIGS. 6, 8, 10 and 12 may be implemented using any of the systems described in connection with FIGS. 1A and 1B.

The aforementioned specific embodiments are illustrative, and many variations can be introduced on these embodiments without departing from the spirit of the disclosure or from the scope of the appended claims. In addition, elements and/or features of different examples and illustrative embodiments may be combined with each other and/or substituted for each other within the scope of this disclosure and appended claims.

What is claimed is:

1. A device and service management application configured to generate a proposed state analysis, the device and service management application including one or more programs of instructions embodied in a non-transitory computer readable medium and executable by a computer to configure the computer to comprise:
an application user interface (UI) to permit a user to specify (i) a site or customer for which a proposed state analysis is to be prepared and (ii) a contract name or code applying to the specified site or customer, and request the proposed state analysis to be prepared; and
a proposed state creation module to retrieve contract data including device models specified by a contract corresponding to the specified contract name or code, and copy current state analysis data for a current fleet of image forming devices of the specified site or customer, as proposed state analysis data, wherein
the proposed state creation module considers in turn each image forming device specified in the proposed state analysis data, including comparing the image forming device to the device models specified by the contract and when the proposed state creation module determines that the image forming device is a replacement target to be replaced, performing a comparison of the replacement target to plural device models registered in a device database to determine a replacement device of a best-fit device model amongst the registered device models.

2. The device and service management application as claimed in claim 1, wherein the replacement device of the best-fit device model determined by the proposed state creation module is the same device type as the replacement target, is the same mono-color capability as that of the replacement target, and has a similar recommended output volume as that of the replacement target.

3. The device and service management application as claimed in claim 1, wherein the proposed state creation module determines, for each specified device model specified by the contract, a corresponding replacement model for the specified device model, by performing a comparison of the specified device model to the plural device models registered in the device database, to determine a best-fit device model amongst the registered device models, and for each replacement target corresponding to the specified device model, the proposed state creation module replaces the replacement target with a replacement device of the corresponding best-fit replacement model.

4. The device and service management application as claimed in claim 1, wherein the image forming device is a replacement target to be replaced, if the image forming device matches any of the device models specified by the contract.

5. The device and service management application as claimed in claim 1, wherein the proposed state creation module determines that the image forming device is to be replaced, if a release date of the image forming device is not more recent than a user-specified old device date.

6. The device and service management application as claimed in claim 1, wherein the application user interface additionally displays a list of the plural device models registered in the device database and permits the user to select a replacement model from the list for a specified device model amongst the device models specified by the contract, and for each replacement target corresponding to the specified device model, the proposed state creation module replaces the replacement target with a replacement device of the corresponding user-selected replacement model.

7. A device and service management application configured to generate a proposed state analysis, the device and service management application including one or more programs of instructions embodied in a non-transitory computer readable medium and executable by a computer to configure the computer to comprise:
an application user interface (UI) to permit a user to specify (i) a site or customer for which a proposed state analysis is to be prepared and (ii) a contract name or code applying to the specified site or customer, and request the proposed state analysis to be prepared; and
a proposed state creation module to retrieve contract data including device models specified by a contract corresponding to the specified contract name or code, and copy current state analysis data for a current fleet of image forming devices of the specified site or customer, as proposed state analysis data, wherein
the proposed state creation module considers in turn each image forming device specified in the proposed state analysis data, including performing a comparison of the image forming device to the device models specified by the contract and when the proposed state creation module determines that the image forming device is to be replaced, replaces the image forming device with a device of a best-fit device model, determined based on the comparison of the image forming device to the device models specified by the contract.

8. The device and service management application as claimed in claim 7, wherein
the application user interface prompts the user to specify both (a) a contract name or code of a current contract applying to the specified site or customer and (b) a contract name or code of a new contract applying to the specified site or customer, and
the proposed state creation module retrieves (c) current contract data including current device models specified by the current contract and (d) new contract data including new device models specified by the new contract, and the proposed state creation module, when considering in turn each image forming device specified in the proposed state analysis data, identifies the image forming device to be a replacement target if the image forming device corresponds to one of the current device models specified by the current contract, and replaces the replacement target with a new device of a best-fit new device model, determined based on a comparison of the replacement target with the new device models specified by the new contract.

9. The device and service management application as claimed in claim 8, wherein the application user interface additionally displays a list of the new device models specified by the new contract, and the application user interface permits the user to select a device model from the list, specify a replacement target amongst the image forming devices specified in the proposed state analysis data, and replace the replacement target in the proposed state analysis data with a new device of the selected device model.

10. The device and service management application as claimed in claim 7, wherein the proposed state creation module determines that the image forming device is to be replaced, if the image forming device does not match any of the device models specified by the contract.

11. The device and service management application as claimed in claim 7, wherein the proposed state creation module determines that the image forming device is to be replaced, if a release date of the image forming device is not more recent than a user-specified old device date.

12. The device and service management application as claimed in claim 7, wherein the application user interface additionally displays a list of the device models specified by the contract, and the application user interface permits the user to select a device model from the list, specify a replacement target amongst the devices specified in the proposed state analysis data, and replace the replacement target in the proposed state analysis data with a new device of the selected device model.

13. The device and service management application as claimed in claim 7, wherein
the application user interface additionally displays a list of the image forming devices specified in the proposed state analysis data and permits the user to select a replacement target in the list, and wherein
the proposed state creation module performs a comparison of the replacement target to the device models specified by the contract and replaces the replacement target with a device of a best-fit device model, determined based on the comparison of the replacement target to the device models specified by the contract.

14. A method performed by a device and service management application including one or more programs of instructions embodied in a non-transitory computer readable medium and executed by a computer, the method comprising:
(b) providing an application user interface (UI) permitting a user to request a proposed state analysis to be prepared, and prompting the user to specify (i) a site or customer for which the proposed state analysis is to be prepared and (ii) a contract name or code applying to the specified site or customer;
retrieving contract data including device models specified by a contract corresponding to the specified contract name or code;
copying current state analysis data for a current fleet of image forming devices of the specified site or customer, as proposed state analysis data;
modifying the proposed state analysis data by considering in turn each image forming device specified in the proposed state analysis data, comparing the image forming device to the device models specified by the contract, and when it is determined that the image forming device is a replacement target to be replaced, performing at least one of (i) a comparison of the replacement target to plural device models registered in a device database to determine a replacement device of a best-fit device model amongst the registered device models, or (ii) replacement of the image forming device with a device of a best-fit device model, determined based on the comparison of the image forming device to the device models specified by the contract.

15. The method as claimed in claim 14, further comprising:
determining, for each specified device model specified by the contract, a corresponding replacement model for the specified device model, by performing a comparison of the specified device model to the plural device models registered in the device database, to determine a best-fit device model amongst the registered device models; and
for each replacement target corresponding to the specified device model, replacing the replacement target with a replacement device of the corresponding best-fit replacement model.

16. The method as claimed in claim 14, further comprising:
providing in the application user interface a list of the plural device models registered in the device database and permitting the user to select a replacement model from the list for a specified device model amongst the device models specified by the contract; and
for each replacement target corresponding to the specified device model, replacing the replacement target with a replacement device of the corresponding user-selected replacement model.

17. The method as claimed in claim 14, further comprising:
providing in the application user interface a list of the device models specified by the contract, and permitting the user to select a device model from the list and specify a replacement target amongst the image forming devices specified in the proposed state analysis data; and
replacing the replacement target in the proposed state analysis data with a new device of the selected device model.

18. The method as claimed in claim 14, further comprising:
providing in the application user interface a list of the image forming devices specified in the proposed state analysis data and permitting the user to select a replacement target in the list; and
performing a comparison of the replacement target to the device models specified by the contract and replacing the replacement target with a device of a best-fit device model, determined based on the comparison of the replacement target to the device models specified by the contract.

19. The method as claimed in claim 14, further comprising:
prompting, by the application user interface, the user to specify both (a) a contract name or code of a current contract applying to the specified site or customer and (b) a contract name or code of a new contract applying to the specified site or customer;
retrieving (c) current contract data including current device models specified by the current contract and (d) new contract data including new device models specified by the new contract; and
when considering in turn each image forming device specified in the proposed state analysis data, identifying the image forming device to be a replacement target if the image forming device corresponds to one of the current device models specified by the current contract, and replacing the replacement target with a new device of a best-fit new device model, determined based on a comparison of the replacement target with the new device models specified by the new contract.
